(19) United States
(12) Patent Application Publication
(10) Pub. No.: US 2026/0265132 A1
(43) Pub. Date: Sep. 10, 2026

(54) LOW CALCIUM CONTENT CEMENTITIOUS MATERIAL

(71) Applicants: Gregory Houchins, Chicago, IL (US); Cyrus Thompson, Chicago, IL (US); Eric Weis, Chicago, IL (US); Venkatasubramanian Viswanathan, Chicago, IL (US); Gaurav N. Sant, Encino, CA (US)

(72) Inventors: Gregory Houchins, Chicago, IL (US); Cyrus Thompson, Chicago, IL (US); Eric Weis, Chicago, IL (US); Venkatasubramanian Viswanathan, Chicago, IL (US); Gaurav N. Sant, Los Angeles, CA (US)

(21) Appl. No.: 19/549,950

(22) Filed: Feb. 25, 2026

Related U.S. Application Data
(63) Continuation-in-part of application No. PCT/US26/14401, filed on Feb. 6, 2026.
(60) Provisional application No. 63/755,111, filed on Feb. 6, 2025.
(60) Provisional application No. 63/763,001, filed on Feb. 25, 2025.

(51) Int. Cl. C04B 14/06; C04B 14/30; C04B 20/02

(52) U.S. Cl. CPC C04B 14/062; C04B 14/30; C04B 20/026

(57) ABSTRACT

Disclosed herein are compositions comprising CaO and SiO₂ at varying ratios.

### CROSS-REFERENCE TO RELATED APPLICATIONS

This application is a continuation-in-part of PCT/US26/14401, filed Feb. 6, 2026, which claims the benefit of U.S. Provisional Application No. 63/755,111 filed Feb. 6, 2025. This application also claims the benefit of U.S. Provisional Application No. 63/763,001, filed Feb. 25, 2026. The contents of each of the foregoing applications are incorporated herein in their entirety by this reference.

### BACKGROUND

The production of cementitious materials is traditionally highly energy and carbon intensive. Mechanochemical techniques (e.g., grinding and milling) represent a suitable alternative to traditional, thermal-based kiln techniques. However, there is a need for improved low-carbon cementitious compositions and methods for producing such materials.

### SUMMARY OF THE INVENTION

In certain aspects, provided herein is a composition comprising a plurality of X(CaO) particles and a plurality of Y(SiO₂) particles, wherein X:Y is from about 0.05 to about 5.

In certain aspects, provided herein is a method of preparing a composition comprising a plurality of first CaO particles and a plurality of first SiO₂ particles, wherein the method comprises:
in a first milling step, milling a plurality of first SiO₂ particles in a mill, thereby forming a plurality of first milled SiO₂ particles;
contacting the plurality of first milled SiO₂ particles with a plurality of first CaO particles in the mill, thereby forming a mixture of a plurality of remilled SiO₂ particles and a plurality of first milled CaO particles; and
in a second milling step, milling the mixture of the plurality of remilled SiO₂ particles and the plurality of first milled CaO particles, thereby forming the composition comprising the plurality of first CaO particles and the plurality of first SiO₂ particles.

In certain aspects, provided herein is a method comprising:
1) in a first milling step, milling a plurality of first particles SiO₂ in a mill, thereby forming a plurality of first milled SiO₂ particles;
2) contacting the plurality of first milled SiO₂ particles with a plurality of first CaO particles in the mill, thereby forming a mixture of a plurality of remilled SiO₂ particles and a plurality of first milled CaO particles; and
3) in a second milling step, milling the mixture of the plurality of remilled SiO₂ particles and the plurality of first milled CaO particles, thereby forming the composition comprising the plurality of first CaO particles and the plurality of first SiO₂ particles.

### BRIEF DESCRIPTION OF THE FIGURES

FIG. 1 is a schematic representation of an exemplary cementitious material particle.

FIG. 2 is a table showing the composition of an exemplary cementitious material, in accordance with the disclosure herein.

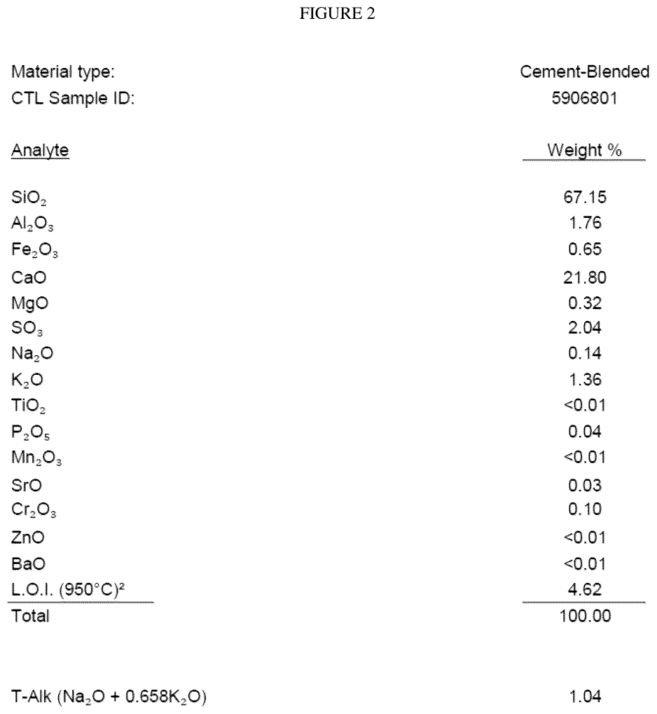

FIG. 3 shows length change data of the cementitious materials described herein when exposed to a sulfate solution. Sulfate exposure was initiated 7-days after cast upon completion of saturated limewater bath cure at 38° C. Exposure class S1: 0.10% at 6 months. Exposure class S2: 0.05% at 6 months, 0.10% at 12 months if the expansion exceeds the 6-month limit. Exposure class S3: 0.10% at 18 months. Flow of the test mixture was 112%.

FIG. 4 shows a second set of length change data of the cementitious materials described herein when exposed to a sulfate solution. Sulfate exposure was initiated 7-days after cast upon completion of saturated limewater bath cure at 38° C. Exposure class S1: 0.10% at 6 months. Exposure class S2: 0.05% at 6 months, 0.10% at 12 months if the expansion exceeds the 6-month limit. Exposure class S3: 0.10% at 18 months. Flow of the test mixture was 112%.

FIG. 5 shows data from an isothermal conduction calorimetry analysis of the cementitious materials described herein. Testing was conducted at 23° C. for 168 hours using external mixing.

FIG. 6 shows a schematic representation of an embodiment for making a cementitious material.

FIG. 7 shows a schematic representation of an embodiment of receiving a silicon oxide powder.

FIG. 8 shows a schematic representation of an embodiment of receiving a calcium oxide powder.

FIG. 9 shows an embodiment of a mill utilized in the method described herein.

FIG. 10 shows an embodiment of a heating chamber or kiln utilized in the method described herein.

FIG. 11 shows an embodiment of a mixer utilized in the method described herein.

### DETAILED DESCRIPTION OF THE INVENTION

The compositions and methods described herein provide a cementitious material produced through milling rather than high-temperature processing, thereby consuming far less energy and generating lower carbon emissions than traditional kiln-based routes. This approach to manufacturing enables decomposition and activation of ingredients that are conventionally thermally processed, such as limestone, through mechanical shock rather than heat. The composition described herein comprises calcium and silica compounds that, when subjected to controlled mechanical treatment, develop distinct reactive and structural features characteristic of cementitious binders. The calcium and silica precursors may include CaO and SiO₂ and may be milled individually or together.

An influential aspect of the production methods described is the sequence of milling. The order in which the constituent compounds are introduced and processed, particularly milling SiO₂ first followed by the addition of CaO, may influence the structure and performance of the resulting material. Although calcium oxide might be expected to dominate process behavior, results indicate that this may not be the case. The mechanical parameters of the milling operation, including mill type and rotational speed, can be selected and adjusted to tune reaction kinetics and particle attributes.

The disclosed framework accommodates a broad range of calcium- and silica-containing compounds, with exemplary embodiments set forth herein. By manipulating the stiffness ratios of constituent phases, the compositions can be tailored to enhance targeted performance attributes. The compliance and compressibility of the resulting materials arise from the elastic stiffness, bulk modulus, and density of the selected precursors and their mechanically induced transformations. Collectively, these features yield cementitious compositions and processes that achieve desirable strength and durability while significantly reducing energy use and carbon intensity relative to kiln-based cement manufacture.

In certain aspects, a composition comprises a plurality of X(CaO) particles and a plurality of Y(SiO₂) particles, wherein X:Y is from about 0.05 to about 5. In certain embodiments, X:Y is about 0.05. In other embodiments, X:Y is about 0.10. In yet other embodiments, X:Y is about 0.15. In yet other embodiments, X:Y is about 0.20. In other embodiments, X:Y is about 0.25. In other embodiments, X:Y is about 0.30. In other embodiments, X:Y is about 0.35. In other embodiments, X:Y is about 0.40. In other embodiments, X:Y is about 0.45. In other embodiments, X:Y is about 0.50. In other embodiments, X:Y is about 0.55. In other embodiments, X:Y is about 0.60. In other embodiments, X:Y is about 0.65. In other embodiments, X:Y is about 0.70. In other embodiments, X:Y is about 0.75. In other embodiments, X:Y is about 0.80. In other embodiments, X:Y is about 0.85. In other embodiments, X:Y is about 0.90. In other embodiments, X:Y is about 0.95. In other embodiments, X:Y is about 1.00. In other embodiments, X:Y is about 1.05. In other embodiments, X:Y is about 1.10. In other embodiments, X:Y is about 1.15. In other embodiments, X:Y is about 1.20. In other embodiments, X:Y is about 1.25. In other embodiments, X:Y is about 1.30. In other embodiments, X:Y is about 1.35. In other embodiments, X:Y is about 1.40. In other embodiments, X:Y is about 1.45. In other embodiments, X:Y is about 1.50. In other embodiments, X:Y is about 1.55. In other embodiments, X:Y is about 1.60. In other embodiments, X:Y is about 1.65. In other embodiments, X:Y is about 1.70. In other embodiments, X:Y is about 1.75. In other embodiments, X:Y is about 1.80. In other embodiments, X:Y is about 1.85. In other embodiments, X:Y is about 1.90. In other embodiments, X:Y is about 1.95. In other embodiments, X:Y is about 2.00. In other embodiments, X:Y is about 2.05. In other embodiments, X:Y is about 2.10. In other embodiments, X:Y is about 2.15. In other embodiments, X:Y is about 2.20. In other embodiments, X:Y is about 2.25. In other embodiments, X:Y is about 2.30. In other embodiments, X:Y is about 2.35. In other embodiments, X:Y is about 2.40. In other embodiments, X:Y is about 2.45. In other embodiments, X:Y is about 2.50. In other embodiments, X:Y is about 2.55. In other embodiments, X:Y is about 2.60. In other embodiments, X:Y is about 2.65. In other embodiments, X:Y is about 2.70. In other embodiments, X:Y is about 2.75. In other embodiments, X:Y is about 2.80. In other embodiments, X:Y is about 2.85. In other embodiments, X:Y is about 2.90. In other embodiments, X:Y is about 2.95. In other embodiments, X:Y is about 3.00. In other embodiments, X:Y is about 3.05. In other embodiments, X:Y is about 3.10. In other embodiments, X:Y is about 3.15. In other embodiments, X:Y is about 3.20. In other embodiments, X:Y is about 3.25. In other embodiments, X:Y is about 3.30. In other embodiments, X:Y is about 3.35. In other embodiments, X:Y is about 3.40. In other embodiments, X:Y is about 3.45. In other embodiments, X:Y is about 3.50. In other embodiments, X:Y is about 3.55. In other embodiments, X:Y is about 3.60. In other embodiments, X:Y is about 3.65. In other embodiments, X:Y is about 3.70. In other embodiments, X:Y is about 3.75. In other embodiments, X:Y is about 3.80. In other embodiments, X:Y is about 3.85. In other embodiments, X:Y is about 3.90. In other embodiments, X:Y is about 3.95. In other embodiments, X:Y is about 4.00. In other embodiments, X:Y is about 4.05. In other embodiments, X:Y is about 4.10. In other embodiments, X:Y is about 4.15. In other embodiments, X:Y is about 4.20. In other embodiments, X:Y is about 4.25. In other embodiments, X:Y is about 4.30. In other embodiments, X:Y is about 4.35. In other embodiments, X:Y is about 4.40. In other embodiments, X:Y is about 4.45. In other embodiments, X:Y is about 4.50. In other embodiments, X:Y is about 4.55. In other embodiments, X:Y is about 4.60. In other embodiments, X:Y is about 4.65. In other embodiments, X:Y is about 4.70. In other embodiments, X:Y is about 4.75. In other embodiments, X:Y is about 4.80. In other embodiments, X:Y is about 4.85. In other embodiments, X:Y is about 4.90. In other embodiments, X:Y is about 4.95. In other embodiments, X:Y is about 5.00.

In certain embodiments, X:Y is from about 0.5 to about 4.5. In certain embodiments, X:Y is from about 1.0 to about 4.0. In further embodiments, X:Y is from about 1.5 to about 3.5. In some embodiments, X:Y is from about 2.0 to about 3.0.

In certain embodiments, the composition is cementitious.

In certain embodiments, the SiO₂ particles have an average particle size from about 10 nm to about 15 microns. In certain embodiments, the SiO₂ particles have an average particle size of about 10 microns. In further embodiments, the SiO₂ particles have an average particle size of about 11 microns. In some embodiments, the SiO₂ particles have an average particle size of about 12 microns. In yet further embodiments the SiO₂ particles have an average particle size of about 13 microns. In yet further embodiments, the SiO₂ particles have an average particle size of about 14 microns. In yet further embodiments, the SiO₂ particles have an average particle size of about 15 microns.

In certain embodiments, the SiO₂ particles have an average particle size of about 100 nm to about 14000 nm. In further embodiments, the SiO₂ particles have an average particle size of about 1000 nm to about 13000 nm. In yet further embodiments, the SiO₂ particles have an average particle size of about 10000 nm to about 12000 nm.

In certain embodiments, the CaO particles have an average particle size from about 10 nm to about 15 microns. In further embodiments, the CaO particles have an average particle size of about 10 microns. In yet further embodiments, the CaO particles have an average particle size of about 11 microns. In still further embodiments, the CaO particles have an average particle size of about 12 microns. In certain embodiments, the CaO particles have an average particle size of about 13 microns. In further embodiments, the CaO particles have an average particle size of about 14 microns. In yet further embodiments, the CaO particles have an average particle size of about 15 microns.

In certain embodiments, the CaO particles have an average particle size of about 100 nm to about 14000 nm. In further embodiments, the CaO particles have an average particle size of about 1000 nm to about 13000 nm. In further embodiments, the CaO particles have an average particle size of about 10000 nm to about 12000 nm.

In certain embodiments, the SiO₂ particles have a diameter 50 (D50) of from about 0.5 microns to about 50 microns. In further embodiments, the SiO₂ particles have a D50 of about 5 microns. In yet further embodiments, the SiO₂ particles have a D50 of about 10 microns. In still further embodiments, the SiO₂ particles have a D50 of about 15 microns. In certain embodiments, the SiO₂ particles have a D50 of about 20 microns. In further embodiments, the SiO₂ particles have a D50 of about 25 microns. In yet further embodiments, the SiO₂ particles have a D50 of about 30 microns. In still further embodiments, the SiO₂ particles have a D50 of about 35 microns. In certain embodiments, the SiO₂ particles have a D50 of about 40 microns. In further embodiments, the SiO₂ particles have a D50 of about 45 microns. In yet further embodiments, the SiO₂ particles have a D50 of about 50 microns.

In certain embodiments, the SiO₂ particles have a D50 of from about 10 microns to about 45 microns. In further embodiments, the SiO₂ particles have a D50 of about 15 microns to about 40 microns. In yet further embodiments, the SiO₂ particles have a D50 of about 20 microns to about 35 microns.

In certain embodiments, the CaO particles have a diameter 50 (D50) of from about 0.5 microns to about 50 microns. In further embodiments, the CaO particles have a D50 of about 5 microns. In yet further embodiments, the CaO particles have a D50 of about 10 microns. In still further embodiments, the CaO particles have a D50 of about 15 microns. In certain embodiments, the CaO particles have a D50 of about 20 microns. In further embodiments, the CaO particles have a D50 of about 25 microns. In further embodiments, the CaO particles have a D50 of about 30 microns. In yet further embodiments, the CaO particles have a D50 of about 35 microns. In still further embodiments, the CaO particles have a D50 of about 40 microns. In certain embodiments, the CaO particles have a D50 of about 45 microns. In further embodiments, the CaO particles have a D50 of about 50 microns.

In certain embodiments, the CaO particles have a D50 of from about 10 microns to about 45 microns. In further embodiments, the CaO particles have a D50 of about 15 microns to about 40 microns. In yet further embodiments, the CaO particles have a D50 of about 20 microns to about 35 microns.

In certain embodiments, the plurality of X(CaO) particles and the plurality of Y(SiO₂) particles are arranged in a disordered structure. In alternative embodiments, the plurality of X(CaO) particles and the plurality of Y(SiO₂) particles are arranged in an ordered structure. In certain embodiments, a composition is amorphous. In alternative embodiments, the composition is crystalline.

In certain embodiments, the SiO₂ is from a natural source (e.g., sand, such as quartz sand, quartzite, quartz, opal, agate, or granite). In further embodiments, the SiO₂ is from rocks. In other embodiments, the SiO₂ is derived from a synthetic source (e.g., pyrogenic silica, precipitated silica, silica gel, colloidal silica, or silica glass). In certain embodiments, the SiO₂ is from fly ash.

In certain embodiments, the composition has a density from about 1.2 g/cm³ to about 5 g/cm3. In further embodiments, the composition has a density of about 1.2 g/cm³. In yet further embodiments, the composition has a density of about 1.5 g/cm³. In still further embodiments, the composition has a density of about 1.8 g/cm³. In certain embodiments, the composition has a density of about 2.0 g/cm³. In further embodiments, the composition has a density of about 2.2 g/cm³. In yet further embodiments, the composition has a density of about 2.5 g/cm³. In still further embodiments, the composition has a density of about 2.8 g/cm³. In certain embodiments, the composition has a density of about 3.0 g/cm³. In further embodiments, the composition has a density of about 3.2 g/cm³. In yet further embodiments, the composition has a density of about 3.5 g/cm³. In still further embodiments, the composition has a density of about 3.8 g/cm³. In certain embodiments, the composition has a density of about 4.0 g/cm³. In further embodiments, the composition has a density of about 4.2 g/cm³. In yet further embodiments, the composition has a density of about 4.5 g/cm³. In still further embodiments, the composition has a density of about 4.8 g/cm³. In certain embodiments, the composition has a density of about 5.0 g/cm³.

In certain embodiments, the density of the composition is from about 1.5 g/cm³ to about 4.5 g/cm³. In further embodiments, the density of the composition is from about 2.0 g/cm³ to about 4.0 g/cm³. In yet further embodiments, the density of the composition is from about 2.5 g/cm³ to about 3.5 g/cm³.

In certain embodiments, the composition can form a hydrate. In further embodiments, the composition can form a hydrate in the presence of an alkaline composition (e.g., a carbonate or hydroxide base).

In certain preferred embodiments, the composition has a ratio of Ca:Si from about 0.05:1 to about 5:1 by wt %. In certain embodiments, the composition has a ratio of Ca:Si of about 0.25:1 wt %. In further embodiments, the composition has a ratio of Ca:Si of about 0.5:1 wt %. In yet further embodiments, the composition has a ratio of Ca:Si of about 0.75:1 wt %. In still further embodiments, the composition has a ratio of Ca:Si of about 1:1 wt %. In certain embodiments, the composition has a ratio of Ca:Si of about 1.25:1 wt %. In further embodiments, the composition has a ratio of Ca:Si of about 1.5:1 wt %. In yet further embodiments, the composition has a ratio of Ca:Si of about 1.75:1 wt %. In still further embodiments, the composition has a ratio of Ca:Si of about 2:1 wt %. In certain embodiments, the composition has a ratio of Ca:Si of about 2.25:1 wt %. In further embodiments, the composition has a ratio of Ca:Si of about 2.5:1 wt %. In yet further embodiments, the composition has a ratio of Ca:Si of about 2.75:1 wt %. In still further embodiments, the composition has a ratio of Ca:Si of about 3:1 wt %. In certain embodiments, the composition has a ratio of Ca:Si of about 3.25:1 wt %. In further embodiments, the composition has a ratio of Ca:Si of about 3.5:1 wt %. In yet further embodiments, the composition has a ratio of Ca:Si of about 3.75:1 wt %. In still further embodiments, the composition has a ratio of Ca:Si of about 4:1 wt %. In certain embodiments, the composition has a ratio of Ca:Si of about 4.25:1 wt %. In further embodiments, the composition has a ratio of Ca:Si of about 4.5:1 wt %. In yet further embodiments, the composition has a ratio of Ca:Si of about 4.75:1 wt %. In still further embodiments, the composition has a ratio of Ca:Si of about 5:1 wt %.

In certain embodiments, the composition has a ratio of Ca:Si from about 0.5:1 to about 4.5:1 by wt %. In further embodiments, the composition has a ratio of Ca:Si from about 1:1 to about 4:1 by wt %. In yet further embodiments, the composition has a ratio of Ca:Si from about 2:1 to about 3:1 by wt %.

In certain preferred embodiments, the composition has a ratio of Ca:Si from about 0.05:1 to about 5:1 by mol %. In certain embodiments, the composition has a ratio of Ca:Si of about 0.25:1 mol %. In further embodiments, the composition has a ratio of Ca:Si of about 0.5:1 mol %. In yet further embodiments, the composition has a ratio of Ca:Si of about 0.75:1 mol %. In still further embodiments, the composition has a ratio of Ca:Si of about 1:1 mol %. In certain embodiments, the composition has a ratio of Ca:Si of about 1.25:1 mol %. In further embodiments, the composition has a ratio of Ca:Si of about 1.5:1 mol %. In yet further embodiments, the composition has a ratio of Ca:Si of about 1.75:1 mol %. In still further embodiments, the composition has a ratio of Ca:Si of about 2:1 mol %. In certain embodiments, the composition has a ratio of Ca:Si of about 2.25:1 mol %. In further embodiments, the composition has a ratio of Ca:Si of about 2.5:1 mol %. In yet further embodiments, the composition has a ratio of Ca:Si of about 2.75:1 mol %. In still further embodiments, the composition has a ratio of Ca:Si of about 3:1 mol %. In certain embodiments, the composition has a ratio of Ca:Si of about 3.25:1 mol %. In further embodiments, the composition has a ratio of Ca:Si of about 3.5:1 mol %. In yet further embodiments, the composition has a ratio of Ca:Si of about 3.75:1 mol %. In still further embodiments, the composition has a ratio of Ca:Si of about 4:1 mol %. In certain embodiments, the composition has a ratio of Ca:Si of about 4.25:1 mol %. In further embodiments, the composition has a ratio of Ca:Si of about 4.5:1 mol %. In yet further embodiments, the composition has a ratio of Ca:Si of about 4.75:1 mol %. In still further embodiments, the composition has a ratio of Ca:Si of about 5:1 mol %.

In certain embodiments, the composition has a ratio of Ca:Si from about 0.5:1 to about 4.5:1 by mol %. In further embodiments, the composition has a ratio of Ca:Si from about 1:1 to about 4:1 by mol %. In yet further embodiments, the composition has a ratio of Ca:Si from about 2:1 to about 3:1 by mol %.

In certain aspects, provided herein is method of preparing a composition comprising a plurality of first CaO particles and a plurality of first SiO₂ particles, wherein the method comprises:
in a first milling step, milling a plurality of first SiO₂ particles in a mill, thereby forming a plurality of first milled SiO₂ particles;
contacting the plurality of first milled SiO₂ particles with a plurality of first CaO particles in the mill, thereby forming a mixture of a plurality of remilled SiO₂ particles and a plurality of first milled CaO particles; and
in a second milling step, milling the mixture of the plurality of remilled SiO₂ particles and the plurality of first milled CaO particles, thereby forming the composition comprising the plurality of first CaO particles and the plurality of first SiO₂ particles.

In certain aspects, provided herein is a method comprising:
1) in a first milling step, milling a plurality of first particles SiO₂ in a mill, thereby forming a plurality of first milled SiO₂ particles;
2) contacting the plurality of first milled SiO₂ particles with a plurality of first CaO particles in the mill, thereby forming a mixture of a plurality of remilled SiO₂ particles and a plurality of first milled CaO particles; and
3) in a second milling step, milling the mixture of the plurality of remilled SiO₂ particles and the plurality of first milled CaO particles, thereby forming the composition comprising the plurality of first CaO particles and the plurality of first SiO₂ particles.

In certain embodiments, the plurality of first particles of SiO₂ have an average particle size from about 100 nm to about 10 mm. In further embodiments, the plurality of first particles of SiO₂ have an average particle size from about 1000 nm to about 1 mm.

In yet further embodiments, the plurality of first particles of SiO₂ have an average particle size from about 10000 nm to about 0.5 mm.

In certain embodiments, the plurality of first particles of CaO have an average particle size from about 100 nm to about 10 mm. In further embodiments, the plurality of first particles of CaO have an average particle size from about 1000 nm to about 1 mm. In yet further embodiments, the plurality of first particles of CaO have an average particle size from about 10000 nm to about 0.5 mm.

In certain embodiments, the first milling step is performed from about 0.25 hours to about 6 hours. In further embodiments, the first milling step is performed for from about 1 hour to about 4 hours.

In certain embodiments, the first milling step and second milling step are performed for a total of less than about 24 hours. In certain embodiments, the first milling step and second milling step are performed for a total of less than about 24 hours. In further embodiments, the first milling step and second milling step are performed for a total of less than about 23 hours. In yet further embodiments, the first milling step and second milling step are performed for a total of less than about 22 hours. In still further embodiments, the first milling step and second milling step are performed for a total of less than about 21 hours. In certain embodiments, the first milling step and second milling step are performed for a total of less than about 20 hours. In further embodiments, the first milling step and second milling step are performed for a total of less than about 19 hours. In yet further embodiments, the first milling step and second milling step are performed for a total of less than about 18 hours. In still further embodiments, the first milling step and second milling step are performed for a total of less than about 16 hours. In certain embodiments, the first milling step and second milling step are performed for a total of less than about 15 hours. In further embodiments, the first milling step and second milling step are performed for a total of less than about 14 hours. In yet further embodiments, the first milling step and second milling step are performed for a total of less than about 13 hours. In still further embodiments, the first milling step and second milling step are performed for a total of less than about 12 hours. In certain embodiments, the first milling step and second milling step are performed for a total of less than about 10 hours. In further embodiments, the first milling step and second milling step are performed for a total of less than about 9 hours. In yet further embodiments, the first milling step and second milling step are performed for a total of less than about 8 hours. In still further embodiments, the first milling step and second milling step are performed for a total of less than about 7 hours. In certain embodiments, the first milling step and second milling step are performed for a total of less than about 6 hours.

In certain embodiments, the mill further comprises a grinding media comprising a plurality of spherical particles. In certain preferred embodiments, the plurality of spherical particles have an average radii of less than about 10 cm. In further embodiments, the plurality of spherical particles have an average radii of less than about 9 cm. In yet further embodiments, the plurality of spherical particles have an average radii of less than about 8 cm. In yet other embodiments, the plurality of spherical particles have an average radii of less than about 7 cm. In yet further embodiments, the plurality of spherical particles have an average radii of less than about 6 cm. In yet further embodiments, the plurality of spherical particles have an average radii of less than about 5 cm.

In certain embodiments, the grinding media is about 10,000 times as large as the CaO and SiO₂ particles.

In certain embodiments, a method is performed at ambient temperature. In further embodiments, the method is performed at about 0° C. In further embodiments, the method is performed at about 5° C. In further embodiments, the method is performed at about 10° C. In yet further embodiments, the method is performed at about 15° C. In further embodiments, the method is performed at about 20° C. In still further embodiments, the method is performed at about 25° C. In certain embodiments, the method is performed at about 30° C. In further embodiments, the method is performed at about 35° C. In yet further embodiments, the method is performed at about 40° C. In still further embodiments, the method is performed at about 45° C. In certain embodiments, the method is performed at about 50° C.

In certain embodiments, the method is performed at about 0° C. to about 50° C. In further embodiments, the method is performed at about 10° C. to about 40° C. In yet further embodiments, the method is performed at about 20° C. to about 30° C.

In certain embodiments, the weight percent of the grinding media in the mill is about 2 wt % as compared to the first SiO₂ particles, the first CaO particles, or the first SiO2 particles and the first CaO particles. In further embodiments, the weight percent of the grinding media in the mill is about 4.5 wt % as compared to the first SiO2 particles, the first CaO particles, or the first SiO₂ particles and the first CaO particles. In yet further embodiments, the weight percent of the grinding media in the mill is about 7 wt % as compared to the first SiO₂ particles, the first CaO particles, or the first SiO₂ particles and the first CaO particles. In still further embodiments, the weight percent of the grinding media in the mill is about 9.5 wt % as compared to the first SiO₂ particles, the first CaO particles, or the first SiO₂ particles and the first CaO particles. In certain embodiments, the weight percent of the grinding media in the mill is about 12 wt % as compared to the first SiO₂ particles, the first CaO particles, or the first SiO₂ particles and the first CaO particles. In further embodiments, the weight percent of the grinding media in the mill is about 14.5 wt % as compared to the first SiO₂ particles, the first CaO particles, or the first SiO₂ particles and the first CaO particles. In yet further embodiments, the weight percent of the grinding media in the mill is about 17 wt % as compared to the first SiO₂ particles, the first CaO particles, or the first SiO₂ particles and the first CaO particles. In still further embodiments, the weight percent of the grinding media in the mill is about 19.5 wt % as compared to the first SiO₂ particles, the first CaO particles, or the first SiO₂ particles and the first CaO particles. In certain embodiments, the weight percent of the grinding media in the mill is about 22 wt % as compared to the first SiO₂ particles, the first CaO particles, or the first SiO₂ particles and the first CaO particles. In further embodiments, the weight percent of the grinding media in the mill is about 24.5 wt % as compared to the first SiO₂ particles, the first CaO particles, or the first SiO₂ particles and the first CaO particles. In yet further embodiments, the weight percent of the grinding media in the mill is about 27 wt % as compared to the first SiO₂ particles, the first CaO particles, or the first SiO₂ particles and the first CaO particles. In still further embodiments, the weight percent of the grinding media in the mill is about 29.5 wt % as compared to the first SiO₂ particles, the first CaO particles, or the first SiO₂ particles and the first CaO particles. In certain embodiments, the weight percent of the grinding media in the mill is about 32 wt % as compared to the first SiO₂ particles, the first CaO particles, or the first SiO₂ particles and the first CaO particles. In further embodiments, the weight percent of the grinding media in the mill is about 34.5 wt % as compared to the first SiO₂ particles, the first CaO particles, or the first SiO₂ particles and the first CaO particles. In yet further embodiments, the weight percent of the grinding media in the mill is about 37 wt % as compared to the first SiO₂ particles, the first CaO particles, or the first SiO₂ particles and the first CaO particles. In still further embodiments, the weight percent of the grinding media in the mill is about 39.5 wt % as compared to the first SiO₂ particles, the first CaO particles, or the first SiO₂ particles and the first CaO particles. In certain embodiments, the weight percent of the grinding media in the mill is about 42 wt % as compared to the first SiO₂ particles, the first CaO particles, or the first SiO₂ particles and the first CaO particles. In further embodiments, the weight percent of the grinding media in the mill is about 44.5 wt % as compared to the first SiO₂ particles, the first CaO particles, or the first SiO₂ particles and the first CaO particles. In yet further embodiments, the weight percent of the grinding media in the mill is about 47 wt % as compared to the first SiO₂ particles, the first CaO particles, or the first SiO₂ particles and the first CaO particles. In still further embodiments, the weight percent of the grinding media in the mill is about 49.5 wt % as compared to the first SiO₂ particles, the first CaO particles, or the first SiO₂ particles and the first CaO particles. In certain embodiments, the weight percent of the grinding media in the mill is about 52 wt % as compared to the first SiO₂ particles, the first CaO particles, or the first SiO₂ particles and the first CaO particles. In further embodiments, the weight percent of the grinding media in the mill is about 54.5 wt % as compared to the first SiO₂ particles, the first CaO particles, or the first SiO₂ particles and the first CaO particles. In yet further embodiments, the weight percent of the grinding media in the mill is about 57 wt % as compared to the first SiO₂ particles, the first CaO particles, or the first SiO₂ particles and the first CaO particles. In still further embodiments, the weight percent of the grinding media in the mill is about 59.5 wt % as compared to the first SiO₂ particles, the first CaO particles, or the first SiO₂ particles and the first CaO particles. In certain embodiments, the weight percent of the grinding media in the mill is about 62 wt % as compared to the first SiO₂ particles, the first CaO particles, or the first SiO₂ particles and the first CaO particles. In further embodiments, the weight percent of the grinding media in the mill is about 64.5 wt % as compared to the first SiO₂ particles, the first CaO particles, or the first SiO₂ particles and the first CaO particles. In yet further embodiments, the weight percent of the grinding media in the mill is about 67 wt % as compared to the first SiO₂ particles, the first CaO particles, or the first SiO₂ particles and the first CaO particles. In still further embodiments, the weight percent of the grinding media in the mill is about 69.5 wt % as compared to the first SiO₂ particles, the first CaO particles, or the first SiO₂ particles and the first CaO particles. In certain embodiments, the weight percent of the grinding media in the mill is about 72 wt % as compared to the first SiO₂ particles, the first CaO particles, or the first SiO₂ particles and the first CaO particles. In further embodiments, the weight percent of the grinding media in the mill is about 74.5 wt % as compared to the first SiO₂ particles, the first CaO particles, or the first SiO₂ particles and the first CaO particles. In yet further embodiments, the weight percent of the grinding media in the mill is about 77 wt % as compared to the first SiO₂ particles, the first CaO particles, or the first SiO₂ particles and the first CaO particles. In still further embodiments, the weight percent of the grinding media in the mill is about 79.5 wt % as compared to the first SiO₂ particles, the first CaO particles, or the first SiO₂ particles and the first CaO particles. In certain embodiments, the weight percent of the grinding media in the mill is about 80 wt % as compared to the first SiO₂ particles, the first CaO particles, or the first SiO₂ particles and the first CaO particles.

In certain embodiments, the weight percent of the grinding media in the mill is from about 10 wt % to about 70 wt % as compared to the first SiO₂ particles, the first CaO particles, or the first SiO₂ particles and the first CaO particles. In further embodiments, the weight percent of the grinding media in the mill is from about 20 wt % to about 60 wt % as compared to the first SiO₂ particles, the first CaO particles, or the first SiO₂ particles and the first CaO particles. In yet further embodiments, the weight percent of the grinding media in the mill is from about 30 wt % to about 50 wt % as compared to the first SiO₂ particles, the first CaO particles, or the first SiO₂ particles and the first CaO particles.

In certain embodiments, the plurality of spherical particles comprises particles of iron, steel, or zirconia, or a combination thereof.

In certain embodiments, the density of each sphere in the plurality of spherical particles is from about 3 g/cm³ to about 8 g/cm³. In further embodiments, the density of each sphere in the plurality of spherical particles is about 3 g/cm³. In yet further embodiments, the density of each sphere in the plurality of spherical particles is about 4 g/cm³. In still further embodiments, the density of each sphere in the plurality of spherical particles is about 5 g/cm³. In certain embodiments, the density of each sphere in the plurality of spherical particles is about 6 g/cm³. In further embodiments, the density of each sphere in the plurality of spherical particles is about 7 g/cm³. In yet further embodiments, the density of each sphere in the plurality of spherical particles is about 8 g/cm³.

In certain embodiments, the density of each sphere in the plurality of spherical particles is from about 4 g/cm³ to about 7 g/cm³. In further embodiments, the density of each sphere in the plurality of spherical particles is from about 5 g/cm³ to about 6 g/cm³.

In certain embodiments, the mill is operated from about 20 RPM to about 20,000 RPM. In further embodiments, the mill is operated at about 20 RPM. In yet further embodiments, the mill is operated at about 100 RPM. In still further embodiments, the mill is operated at about 200 RPM. In certain embodiments, the mill is operated at about 300 RPM. In further embodiments, the mill is operated at about 400 RPM. In yet further embodiments, the mill is operated at about 500 RPM. In still further embodiments, the mill is operated at about 1,000 RPM. In certain embodiments, the mill is operated at about 2,000 RPM. In further embodiments, the mill is operated at about 3,000 RPM. In yet further embodiments, the mill is operated at about 4,000 RPM. In still further embodiments, the mill is operated at about 5,000 RPM. In certain embodiments, the mill is operated at about 6,000 RPM. In further embodiments, the mill is operated at about 7,000 RPM. In yet further embodiments, the mill is operated at about 8,000 RPM. In still further embodiments, the mill is operated at about 9,000 RPM. In certain embodiments, the mill is operated at about 10,000 RPM. In further embodiments, the mill is operated at about 11,000 RPM. In yet further embodiments, the mill is operated at about 12,000 RPM. In still further embodiments, the mill is operated at about 13,000 RPM. In certain embodiments, the mill is operated at about 14,000 RPM. In further embodiments, the mill is operated at about 15,000 RPM. In yet further embodiments, the mill is operated at about 16,000 RPM. In certain embodiments, the mill is operated at about 17,000 RPM. In further embodiments, the mill is operated at about 18,000 RPM. In yet further embodiments, the mill is operated at about 19,000 RPM. In certain embodiments, the mill is operated at about 20,000 RPM.

In certain embodiments, the mill is operated from about 200 RPM to about 2,000 RPM. In further embodiments, the mill is operated from about 500 RPM to about 1,500 RPM. In yet further embodiments, the mill is operated from about 700 RPM to about 1,200 RPM.

In certain embodiments, the mill further comprises a grinding aid. In certain embodiments, the grinding aid comprises an amine, a glycol, or a carboxylic acid, or a combination thereof. In further embodiments, wherein the grinding aid is an amine, preferably the amine is diethanol isopropanolamine (DEIPA). In yet further embodiments, the grinding aid is carboxylic acid.

In certain embodiments, the mill is a planetary ball mill, an attritor ball mill, a vibratory ball mill, a horizontal ball mill, or a grate ball mill. In certain embodiments, the mill is a ball mill.

In other embodiments, the mill is a jet mill. In yet other embodiments, the mill is a vertical roller mill. In yet other embodiments, the mill is a stirred media mill.

In certain embodiments, the composition described above is formed by any one of the methods described above.

In certain embodiments, a construction material is provided comprising a composition of any one of the compositions described above.

In certain embodiments, a method of making a construction material is provided, comprising contacting any one of the described compositions with water.

### ADDITIONAL EMBODIMENTS

### 1. Overview

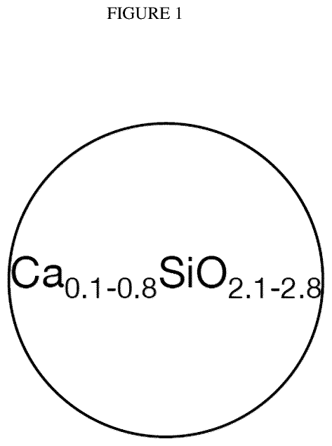

As shown in FIG. 1, embodiments of the cementitious materials disclosed herein comprise particles having (sub-stoichiometric calcium content relative to silicon content. In some embodiments, the cementitious material comprises additives to improve resilience, chemical resistance (e.g., to sulfuric acid, chlorine, etc.), freeze-thaw behavior, coefficient of thermal expansion, mechanical strength, viscosity, slurry stability, and/or other properties of the cementitious material (e.g., before, during, and/or after setting).

In certain preferred embodiments, the cementitious materials are used to form cements with a compressive strength exceeding, for embodiment, about 5 MPa after about 28 days of curing. However, the cementitious material can additionally or alternatively be used for concrete, mortar, plaster, hydraulic cement, stucco, grout, screeds, insulation, fire protection, acid mine drainage remediation, sealants, agriculture (as a source of calcium and/or silicon), as a food additive, as a phosphate or other runoff trap, for cosmetics, for pharmaceuticals, and/or for other suitable purposes.

### 2. Embodiments

In certain embodiments, the cementitious materials described herein comprise a calcium silicate with a ratio of calcium to silicon from about 0.1 to about 0.8. In certain embodiments, the cementitious material comprise silica (e.g., up to about 50 wt % silica to 50 wt % calcium silicate). In certain embodiments, the cementitious materials comprise alumina (e.g., the oxide content as measured for instance using XRF can include up to about 10 wt % aluminum oxides relative to calcium silicate, calcium oxide, silica, and/or other oxide species; where the aluminum oxides can include alumina, aluminosilicates, calcium aluminates, calcium alumininosilicates, etc.). In certain such embodiments, the cementitious material is a powder (e.g., comprising particles of calcium silicate). A characteristic size (e.g., D50 size) of the particles can be from about 100 nm to about 100 μm (e.g., about 200 nm, about 500 nm, about 1 μm, about 2 μm, about 5 μm, about 10 μm, about 20 μm, about 50 μm, values or ranges therebetween, etc.). In certain preferred embodiments, a surface area of the particles is large (e.g., preferably about 500 m²/kg, about 1000 m²/kg, about 2000 m²/kg, about 4000 m²/kg, about 5000 m²/kg, about 10000 m²/kg, values or ranges therebetween, >about 10000 m²/kg, etc.).

### 3. Exemplary Technical Advantages

In certain embodiments, the technology and materials disclosed herein result in a lower carbon intensity cement compared to traditional cements. In some embodiments, the reduction in carbon intensity results from using a lower calcium content as the calcium in cement traditionally is produced by calcining limestone (e.g., calcium carbonate) which releases CO₂ (concomitantly with producing CaO used to form the cementitious material). By using lower calcium content, less limestone is needed and thus less CO₂ is released. In some embodiments, the reduction in carbon intensity results from processes used to produce such a material having a lower energy cost compared to traditional kiln firing at temperatures exceeding about 1000° C. to activate the calcium silicate material. For instance, electrolytic processes (such as that described in U.S. patent application Ser. No. 17/771,197 titled ‘ELECTROCHEMICAL SYNTHESIS OF CEMENTITIOUS COMPOUNDS’ filed 22 Apr. 2022 which is incorporated in its entirety by this reference) can be used to produce the cementitious material at temperatures closer to room temperature (e.g., at temperatures≤about 200° C.).

In certain embodiments, the technology and materials disclosed hereinresult in low calcium content hydraulically active cement. In certain embodiments, the properties of the hydraulically active cement on a crystallinity of the cementitious materials, a grain size of the cementitious materials, a composition (calcium content, ratio of calcium to silicon, presence or absence of residual or additive species, etc.) of the cementitious materials, a surface property of the cementitious material (or materials thereof such as a surface functionalization, surface termination, etc.), and/or other aspects of the cementitious material can modulate the hydraulic activity. In certain embodiments, the cementitious material has a compressive strength exceeding about 20 MPa after 7 days of curing. In certain embodiments, the cementitious material has a compressive strength exceeding about 28 MPa after 28 days of curing. In certain, the cementitious material has a compressive strength exceeding about 35 MPa after 90 days of curing. In certain embodiments, the cementitious material has a compressive strength exceeding about 5 MPa after 7 days of curing.

The embodiments set forth above are non-limiting and further advantages may be provided by the technology and materials disclosed herein.

### 4. Cementitious Material

As shown in FIG. 1, embodiments of the cementitious materials comprise particles having (e.g., consisting of, composed of, consisting essentially of, composed essentially of, including predominantly, with a majority composition of, including, comprising, etc.) substoichiometric calcium content relative to silicon content.

In certain preferred embodiments, the cementitious materials disclosed herein comprise a calcium silicate. In certain preferred embodiments, the calcium silicate is substoichiometric in calcium relative to silicon. In certain preferred embodiments, the stoichiometric ratio of calcium to silicon is from about 0.1 to about 0.8. When the stoichiometric ratio of calcium is less than about 0.1, the resulting cementitious material can have a lower (e.g., less than a target value, insufficient, less than desirable, etc.) compressive strength. Relatedly, higher stoichiometric ratios can result in a high carbon intensity (e.g., CO₂ emissions greater than about 1 kg CO₂ emitted/kg of cementitious material produced).

In certain preferred embodiments, the calcium silicate is amorphous or nanocrystalline (e.g., has crystal grains with a characteristic size less than about 100 nm). For example, the calcium silicate can have a grain size from about 0.01 nm to about 100 nm (e.g., about 0.01 nm, about 0.1 nm, about 1 nm, about 10 nm, about 20 nm, about 30 nm, about 40 nm, about 50 nm, about 60 nm, about 70 nm, about 80 nm, about 90 nm, about 100 nm, and/or any value or range therebetween). However, the calcium silicate can have any suitable crystallinity and/or crystal grain size. In certain embodiments, the crystallinity (or lack thereof) can be measured using x-ray diffraction (e.g., based on a linewidth, peak position, etc. in x-ray diffraction scans), x-ray photoelectron spectroscopy, nuclear magnetic resonance spectroscopy, electron diffraction, scanning transmission electron micrographs (STEM), vibrational spectroscopy (e.g., resonant vibration transition frequencies, vibrational transition linewidths, etc. such as Raman, Fourier transform infrared spectroscopy, etc.), and/or other suitable techniques.

In certain preferred embodiments, The calcium silicate is particulate. A characteristic size (e.g., D50 size, diameter, hydrodynamic radius, Stokes radius, width, length, depth, etc.) of the particles can be from about 100 nm to about 100 μm (e.g., about 200 nm, about 500 nm, about 1 μm, about 2 μm, about 5 μm, about 10 μm, about 20 μm, about 50 μm, values or ranges therebetween, etc.). When particles are less than about 100 nm, forming a slurry of particles (e.g., to form cement) can be difficult (e.g., the viscosity, flow, etc. properties of the slurry can be inadequate for formation of cement, a curing time can be too long, etc.). Similarly, cements formed from cementitious material that includes calcium silicate with characteristic particle size greater than about 100 μm can have inadequate properties (e.g., low compressive strength) from issues with curing, slurry stability, and/or other problems. The characteristic size can be measured using vibrational spectroscopy, x-ray diffraction, direct imaging (e.g., electron beam imaging, neutron imaging, etc.), dynamic light scattering, and/or using other suitable techniques.

The calcium silicate particles can exhibit a high specific surface area. In certain embodiments, the specific surface area of the calcium silicate particles can be from about 5 m²/g to about 200 m²/g (e.g., about 5 m²/g, about 10 m²/g, about 20 m²/g, about 30 m²/g, about 40 m²/g, about 50 m²/g, about 75 m²/g, about 100 m²/g, about 125 m²/g, about 150 m²/g, about 175 m²/g, about 200 m²/g, and/or any value or range therebetween). In certain embodiments, the specific surface area can be from about 200 m²/g to about 10,000 m²/kg (e.g., about 500 m²/kg, about 1,000 m²/kg, about 2,000 m²/kg, about 4,000 m²/kg, about 5,000 m²/kg, about 7,500 m²/kg, about 10,000 m²/kg, and/or any value or range therebetween). In certain embodiments, the specific surface area can exceed about 10,000 m²/kg. The specific surface area can be measured using Brunauer-Emmett-Teller (BET) nitrogen adsorption, krypton adsorption, water vapor adsorption, or other suitable gas adsorption techniques. A high specific surface area can enhance hydration kinetics, increase chemical reactivity, promote formation of binding phases during curing, and/or enable hydraulic activity even at reduced calcium-to-silicon ratios.

In certain embodiments, the cementitious material can be formed by mechanically activating a mixture of calcium oxide and silicon oxide. Mechanical activation comprises one or more of agitation, mixing, milling, grinding, attrition, shearing, impact milling, ball milling, planetary milling, vibratory milling, jet milling, stirred media milling, high-energy milling, and/or other suitable solid-state processing techniques. In certain embodiments, calcium oxide and silicon oxide are reacted in the solid state under mechanical energy to form calcium silicate phases. Mechanical activation can induce lattice strain, crystal defects, partial amorphization, increased defect density, and/or metastable bonding configurations within the calcium silicate. These effects can increase reactivity with water, enhance hydration kinetics, and enable formation of hydraulically active binding phases without requiring high-temperature kiln firing. In some embodiments, mechanical activation can occur at temperatures less than about 500° C. (e.g., less than about 400° C., about 300° C., about 200° C., about 150° C., about 100° C., about 75° C., about 50° C., room temperature, and/or any value or range therebetween).

In embodiments where calcium oxide and/or calcium hydroxide and silicon oxide are mechanically reacted, the particle sizes of the calcium oxide and silicon oxide are selected to promote intimate mixing and efficient solid-state reaction. In some embodiments, the silicon oxide is milled to a characteristic particle size from about 0.1 μm to about 10 μm (e.g., about 0.1 μm, about 0.2 μm, about 0.3 μm, about 0.5 μm, about 0.7 μm, about 1 μm, about 2 μm, about 3 μm, about 5 μm, about 7 μm, about 10 μm, and/or any value or range therebetween). In some embodiments, the calcium oxide is milled to a characteristic particle size from about 0.1 μm to about 20 μm (e.g., about 0.1 μm, about 0.2 μm, about 0.5 μm, about 1 μm, about 2 μm, about 5 μm, about 7 μm, about 10 μm, about 15 μm, about 20 μm, and/or any value or range therebetween). In some embodiments, the calcium oxide and silicon oxide have substantially similar particle sizes prior to mechanical activation. Reducing the particle sizes of both reactants can increase contact area, reduce diffusion length scales, suppress formation of unreacted lime, improve reaction uniformity, and/or enhance formation of amorphous or nanocrystalline calcium silicate phases during mechanical activation.

In embodiments where the cementitious material is formed from calcium oxide and silicon oxide precursors, the relative amounts of calcium oxide and silicon oxide are selected to yield a desired calcium-to-silicon ratio in the resulting calcium silicate. In certain embodiments, the ratio of calcium oxide to silicon oxide is defined on a molar basis, a mass basis, a weight percent basis, a volume basis, and/or a stoichiometric basis. In some embodiments, the calcium oxide and silicon oxide are combined in relative molar amounts selected to yield a calcium-to-silicon atomic ratio from about 0.1 to about 0.8 (e.g., about 0.1, about 0.15, about 0.2, about 0.25, about 0.3, about 0.35, about 0.4, about 0.45, about 0.5, about 0.6, about 0.7, about 0.8, and/or any value or range therebetween). In certain embodiments, the calcium oxide is from about 5 wt % to about 60 wt % of the combined calcium oxide and silicon oxide (e.g., about 5 wt %, about 10 wt %, about 15 wt %, about 20 wt %, about 25 wt %, about 30 wt %, about 35 wt %, about 40 wt %, about 45 wt %, about 50 wt %, about 55 wt %, about 60 wt %, and/or any value or range therebetween), with the balance being silicon oxide. In some embodiments, the calcium oxide and silicon oxide are combined in non-stoichiometric proportions relative to crystalline calcium silicate phases, such that the resulting calcium silicate is amorphous or nanocrystalline. Selecting the relative amounts of calcium oxide and silicon oxide can control the phase composition, degree of polymerization of silicate units, defect density, surface chemistry, hydraulic reactivity, and/or carbon intensity of the resulting cementitious material.

In some embodiments, the cementitious material comprises additives and/or dopants to improve resilience, chemical resistance (e.g., to sulfuric acid, chlorine, etc.), freeze-thaw behavior, coefficient of thermal expansion, mechanical strength, viscosity, slurry stability, curing of (e.g., time to cure), compressive strength of the as cured cement, appearance (e.g., color) of the as cured cement, and/or other properties of the cementitious material (e.g., before, during, and/or after setting or curing). In certain embodiments, the additives, additionally or alternatively, comprise residual materials introduced in the formation of calcium silicate (e.g., silica, lime, calcium carbonate, calcium oxide, calcite, lime, quick lime, slaked lime, calcium hydroxide, silicon, carbon, gypsum, etc.). Exemplary additives include: aluminum oxide, iron oxide, sulfur oxide, magnesium oxide, chromium oxide, manganese oxide, titanium oxide, alkali metals (e.g., lithium, sodium, potassium, rubidium, caesium, etc. typically as an oxide), and/or other suitable oxides (e.g., metal oxides) or other materials. In certain embodiments, set modifiers, retarders (e.g., gypsum, calcium sulfate, lignosulfonates, citric acid, sugar, etc.), and/or accelerators (e.g., calcium chloride, sodium nitrate, sodium thiocyanate, etc.) can be included in the cementitious material (e.g., from about 0.5 to about 10%) to control the setting time. In certain embodiments, aggregates (e.g., sand, gravel, etc.), fillers (e.g., limestone, quartz, fly ash, metakaolin, etc.), fibers (e.g., steel fibers, glass fibers, etc.), plasticizers, and/or any other suitable additive are included in the cementitious material (e.g., to alter its physical properties, etc.).

In some embodiments, dopants are incorporated in small quantities to modify the chemical or crystalline structure of the cement, improve hydration kinetics, and/or enhance performance properties. Examples of dopants include alkaline oxides (e.g., Na₂O, K₂O), alkaline earth oxides (e.g., MgO, CaO, SrO), halogens (e.g., F⁻, Cl⁻, Br⁻), transition metal oxides (e.g., Fe₂O₃, TiO₂, MnO₂), rare earth oxides, or any other suitable dopant. In certain preferred embodiments, the dopants are less than about 1 wt % of the cementitious material. The 1 wt % can refer to a total wt % of additives and/or a wt % of a specific additive (where each additive can contribute up to about 10 wt % each). However in some embodiments, the cementitious material has a composition with a dopant weight percentage greater than about 1 wt %.

In certain preferred embodiments, the additives and/or dopants are at most about 10 wt % of the cementitious material. The 10 wt % refers to a total wt % of additives or dopants and/or a wt % of a specific additive or dopants (where each additive or dopant contributes up to about 10 wt % each). In other embodiments, the cementitious material includes at most about 10 wt % impurities.

However, in some embodiments (particularly but not exclusively when the additives comprise silica or other silicon oxide species such as quartz), the additives are up to about 60 wt % of the cementitious material. In certain embodiments, cementitious materials comprise about 10 wt % aluminum oxide (or related aluminum minerals such as aluminosilicates, calcium aluminates, calcium aluminosilicates, etc.), about 50 wt % silica, and about 40 wt % calcium silicate (e.g., as described above). However, other compositions can be used (up to and including about 100 wt % calcium silicate).

The additives and/or dopant composition can be determined using x-ray fluorescence, particle-induced X-ray emission, X-ray photoelectron spectroscopy, Auger electron spectroscopy, mass spectrometry, energy-dispersive X-ray spectroscopy, cathodoluminescence, nuclear magnetic resonance spectroscopy, and/or using other suitable technique(s).

In use, the cementitious material can be mixed with water to initiate hydration and setting. The water-to-cementitious-material ratio can be from about 0.1 to about 1.0 by mass (e.g., about 0.1, about 0.15, about 0.2, about 0.25, about 0.3, about 0.35, about 0.4, about 0.45, about 0.5, about 0.6, about 0.7, about 0.8, about 0.9, about 1.0, and/or any value or range therebetween). Upon contact with water, the amorphous and/or nanocrystalline calcium silicate can undergo hydration through dissolution, surface hydration, and/or precipitation mechanisms to form binding phases (e.g., calcium-silicate-hydrate-like phases). In some embodiments, hydration proceeds without formation of substantial portlandite. In some embodiments, hydration occurs at ambient temperature and pressure. The hydration process can result in progressive densification of the cementitious matrix, development of mechanical strength, reduction of porosity, and/or improved durability over time.

After initial mixing with water, the cementitious material undergoes setting, which is the transition from a plastic, moldable state to a solid or semi-solid form. Under normal curing conditions, setting and/or curing can occur at ambient temperature and pressure over several hours to days (e.g., about 1 hour, about 2 hours, about 3 hours, about 4 hours, about 5 hours, about 6 hours, about 8 hours, about 10 hours, about 12 hours, about 24 hours, about 2 days, about 3 days, about 4 days, about 5 days, about 10 days, about 14 days, about 28 days, about 90 days, or any value therebetween), depending on the water-to-cementitious-material ratio, particle size, and chemical composition of the cementitious material. During this period, the progressive formation of binding phases, such as calcium-silicate-hydrate-like structures, gradually increases the mechanical strength and reduces porosity. In other embodiments, setting and/or curing can involve maintaining appropriate moisture and temperature conditions to allow continued hydration, densification, and strength development. Conventional curing techniques include maintaining high relative humidity (e.g., above about 80%, above about 90%, above about 95%, above about 99%), covering the material with wet fabrics or plastic sheets, or submerging the material in water to prevent moisture loss. In some embodiments, accelerated curing methods are applied to achieve faster strength development or enhanced early-age performance. Such methods can include elevated temperature curing, such as steam curing (e.g., about 50 to about 90° C.) or hot water immersion, autoclaving under pressurized conditions, or exposure to chemical accelerators. Additionally, techniques such as controlled curing chambers, microwave-assisted curing, or induction heating can provide rapid hydration and densification while still allowing the cementitious matrix to develop long-term mechanical properties. However, setting and/or curing can be otherwise performed.

In certain preferred embodiments, after setting and/or curing, the cementitious material as described above meets or exceeds the mechanical properties of other hydraulic cements (e.g., Portland cement, alite, belite, tricalcium aluminate, brownmillerite, etc.). For instance, after 7 days for setting (i.e., drying after being mixed with water), embodiments of the cementitious material can achieve a compressive strength exceeding about 3 MPa (e.g., about 5 MPa, about 7 MPa, about 8 MPa, about 10 MPa, about 12 MPa, about 15 MPa, about 20 MPa, about 25 MPa, about 28 MPa, about 30 MPa, about 40 MPa, etc.). Similarly, after 28 days for setting, embodiments of the cementitious material can achieve a compressive strength exceeding about 5 MPa (e.g., about 7 MPa, about 9 MPa, about 10 MPa, about 12 MPa, about 15 MPa, about 20 MPa, about 25 MPa, about 28 MPa, about 30 MPa, about 35 MPa, about 40 MPa, about 44 MPa, about 50 MPa, about 52 MPa, about 58 MPa, about 61 MPa, about 65 MPa, about 70 MPa, values or ranges therebetween, etc.). Similarly, after 90 days for setting, embodiments of the cementitious material can achieve a compressive strength exceeding about 7.5 MPa (e.g., about 10 MPa, about 12 MPa, about 15 MPa, about 20 MPa, about 25 MPa, about 28 MPa, about 30 MPa, about 33 MPa, about 35 MPa, about 36 MPa, about 40 MPa, about 44 MPa, about 50 MPa, about 52 MPa, about 58 MPa, about 61 MPa, about 65 MPa, about 70 MPa, about 77 MPa, about 82 MPa, about 85 MPa, about 90 MPa, about 93 MPa, about 96 MPa, about 98 MPa, about 100 MPa, about 110 MPa, values or ranges therebetween, etc.). However, the cementitious material can achieve other suitable compressive strength. For comparison, typical Portland cement concrete sets in approximately 6 hours and develops a compressive strength of about 8 MPa in 24 hours, rises to about 15 MPa at 3 days, about 23 MPa at 1 week, about 35 MPa at 4 weeks, and approximately 41 MPa at 3 months. In this context, the cementitious materials described herein are capable of meeting or exceeding these standard performance benchmarks, demonstrating suitability for applications traditionally served by Portland cement and other conventional hydraulic cements.

Relatedly, embodiments of the cementitious material achieve comparable or superior chemical stability of cement, freeze-thaw behavior, and/or other suitable properties as compared to Portland cement (or other hydraulic cement). In certain preferred embodiments, cement formed using the cementitious materials described herein have superior stability to sulphate (e.g., sulfuric acid). One hypothesis as to the source of this improved chemical resistance is because of a reduced aluminum content in the cementitious material (as compared to Portland cement); however, other aspects of the cementitious material can additionally or alternatively contribute to or result in the improved chemical stability.

During and/or after setting and curing, the cementitious material can exhibit different structural states depending on composition, curing conditions, and reaction pathways. In some embodiments the cementitious material remains amorphous or nanocrystalline calcium silicate hydrate (C-S-H). In other embodiments, the hydration reaction results in the formation of partially or fully crystalline calcium silicate hydrate phases, including but not limited to tobermorite-type, xonotlite-type, jennite-type, gyrolite-type, afwillite-type, and/or thaumasite-type structures, depending on curing temperature, moisture availability, and ageing conditions. The relative proportion of crystalline versus amorphous or nanocrystalline phases can vary with factors such as temperature, curing duration, water availability, dopants, and/or additives. In contrast to conventional Portland cement systems, which typically produce significant quantities of calcium hydroxide (Ca(OH)₂) during hydration, the cementitious materials described herein can, in some embodiments, form reduced amounts of Ca(OH)₂ and increased proportions of C-S-H-rich binding phases, consistent with its lower calcium content and mechanically enhanced reactivity. These hydration pathways can contribute to improved chemical stability, reduced susceptibility to acid or sulfate attack, and enhanced long-term durability. However, other hydration reactions and phase assemblages are also possible, and the cementitious material is not limited to any single crystallinity state or reaction mechanism. The hydration reactions can proceed through mechanically enabled or pozzolanic-type reaction pathways, wherein the mechanically activated silica reacts with calcium species to form binding hydrates. These hydration pathways can contribute to improved chemical stability, reduced susceptibility to acid or sulfate attack, and enhanced long-term durability. However, other hydration reactions and phase assemblages are also possible, and the cementitious material is not limited to any single crystallinity state or reaction mechanism.

In certain embodiments, the cementitious material described herein can alternatively be formed using electrochemical processes (e.g., be formed using an electrolysis cell as described in U.S. patent application Ser. No. 17/771,197 titled ‘ELECTROCHEMICAL SYNTHESIS OF CEMENTITIOUS COMPOUNDS’ filed 22 Apr. 2022 which is incorporated in its entirety by this reference). However, thermal chemical approaches (e.g., using flash freezing to form amorphous or nanocrystalline calcium silicate phases), high energy bombardment (e.g., gamma ray bombardment), and/or other processes can be used to achieve similar cementitious materials (e.g., where additives can be added separately).

### 5. Exemplary Embodiments

Specific Embodiment 1. A cementitious material, comprising: a plurality of calcium silicate particles, wherein the calcium silicate particles have a substoichiometric calcium content relative to silicon, a nanocrystalline structure, and a specific surface area from about 1000 m²/kg to about 10000 m²/kg.

Specific Embodiment 2. The cementitious material of Specific Embodiment 1, wherein a calcium-to-silicon atomic ratio is from about 0.1 to about 0.8.

Specific Embodiment 3. The cementitious material of Specific Embodiment 2, wherein the calcium-to-silicon atomic ratio is from about 0.2 to about 0.75.

Specific Embodiment 4. The cementitious material of Specific Embodiment 1, wherein the calcium silicate particles have a crystal grain size of less than about 100 nm.

Specific Embodiment 5. The cementitious material of Specific Embodiment 1, wherein the plurality of calcium silicate particles has a D50 particle size from about 100 nm to about 100 μm.

Specific Embodiment 6. The cementitious material of Specific Embodiment 1, wherein the cementitious material is hydraulic, wherein after mixing with water and curing for 28 days, the cementitious material exhibits a compressive strength of at least about 5 MPa.

Specific Embodiment 7. The cementitious material of Specific Embodiment 1, further comprising additives, wherein a total amount of additives present in the cementitious material is from about 0.1 wt % to about 10 wt % of the cementitious material.

Specific Embodiment 8. The cementitious material of Specific Embodiment 7, wherein the additives comprise gypsum or calcium sulfate.

Specific Embodiment 9. The cementitious material of Specific Embodiment 7, wherein the additives comprise one or more metal oxides selected from the group consisting of aluminum oxide, iron oxide, magnesium oxide, sulfur oxide, titanium oxide, chromium oxide, manganese oxide, or alkali metal oxides.

Specific Embodiment 10. The cementitious material of Specific Embodiment 7, wherein the additives an alkali metal oxide selected from the group consisting of lithium oxide, sodium oxide, potassium oxide, or combinations thereof.

Specific Embodiment 11. The cementitious material of Specific Embodiment 7, wherein the additives comprise an aluminum-containing compound selected from the group consisting of aluminum oxide, aluminosilicates, calcium aluminates, calcium aluminosilicates, or combinations thereof.

Specific Embodiment 12. A composite material, comprising: a cementitious material consisting essentially of amorphous calcium silicate with a calcium-to-silicon atomic ratio of less than about 0.75; and a particulate morphology.

Specific Embodiment 13. The composite material of Specific Embodiment 12, wherein the calcium-to-silicon atomic ratio is from about 0.1 to about 0.75.

Specific Embodiment 14. The composite material of Specific Embodiment 12, wherein the calcium silicate has a D50 particle size from about 100 nm to about 100 μm.

Specific Embodiment 15. The composite material of Specific Embodiment 12, further comprising additives, wherein a total amount of additives present in the cementitious material is from about 0.1 wt % to about 10 wt % of the cementitious material.

Specific Embodiment 16. The composite material of Specific Embodiment 15, wherein the additives comprise an aluminum-containing compound selected from the group consisting of aluminum oxide, aluminosilicates, calcium aluminates, calcium aluminosilicates, or combinations thereof.

Specific Embodiment 17. The composite material of Specific Embodiment 15, wherein the additives comprise gypsum or calcium sulfate.

Specific Embodiment 18. The composite material of Specific Embodiment 15, wherein the additives comprise one or more metal oxides selected from the group consisting of aluminum oxide, iron oxide, magnesium oxide, sulfur oxide, titanium oxide, chromium oxide, manganese oxide, or alkali metal oxides.

Specific Embodiment 19. The composite material of Specific Embodiment 12, wherein the cementitious material is hydraulic, wherein after mixing with water and curing for 28 days, the cementitious material exhibits a compressive strength of at least about 5 MPa.

Specific Embodiment 20. The composite material of Specific Embodiment 12, wherein the amorphous calcium silicate has a specific surface area from about 1 m²/g to about 100 m²/g.

Specific Embodiment 21. A mechanically activated calcium silicate with a sub-stoichiometric calcium to silicon atomic ratio.

Specific Embodiment 22. The mechanically activated calcium silicate of Specific Embodiment 21 with any of the properties of a calcium silicate material of one or more of specific embodiments 1-20.

In illustrative embodiments, the methods disclosed herein may comprise: milling silicon oxide to a small particle size (e.g., 0.01-10 μm) and amorphous or nanocrystalline crystallinity, optionally milling a calcium oxide and/or calcium hydroxide powder (e.g., 10-100 μm), and co-milling (e.g., at between 100 and 500 rpm) the calcium oxide and/or calcium hydroxide powder with the milled silicon oxide powder to mechanically activate the mixture. In certain embodiments, milling silicon oxides, calcium oxide, and/or calcium hydroxide (e.g., preferably >90% of the time spent, or more preferably >99% if the time spent) occurs during Rittinger phase of grinding while co-milling the milled silicon oxide and calcium oxide and/or calcium hydroxide primarily (e.g., preferably >90% of the time spent, or more preferably >99% of the time spent) or occurs during the aggregation and/or agglomeration phase of grinding. In some embodiments, the methods disclosed herein can further comprise introducing additives (e.g. gypsum, alkaline substance, etc.) and/or heat to the mixture to alter the physical properties of the resultant cement. In certain embodiments, the calcium oxide powder is formed from calcined limestone (calcium carbonate), wherein the limestone is optionally milled prior to and/or contemporaneously with calcining.

In further embodiments, the cementitious material comprises a calcium silicate with a ratio of calcium to silicon between 0.1 and 0.8. In some embodiments, the cementitious material comprises silica (e.g., up to about 50 wt % silica to 50 wt % calcium silicate). In certain embodiments the cementitious material comprises alumina (e.g., the oxide content as measured by, for example, X-ray Fluorescence (XRF), up to about 10 wt % aluminum oxides relative to calcium silicate, calcium oxide, silica, and/or other oxide species; where the aluminum oxides comprise alumina, aluminosilicates, calcium aluminates, calcium alumininosilicates, etc.). In preferred embodiments, the cementitious material is a powder (e.g., comprising particles of calcium silicate). In further preferred embodiments, the cementitious material is nanocrystalline and/or amorphous.

### 3. Technical Advantages

In certain embodiments, the technology and methods disclosed herein have a lower carbon intensity cement compared to traditional cements. In some embodiments, the reduction in carbon intensity results from using a lower calcium content, as the calcium in cement traditionally is produced by calcining limestone (e.g., calcium carbonate) which releases CO₂, concomitantly with producing CaO used to form the cementitious material. By using lower calcium content, less limestone is needed and thus less CO₂ is released. In some embodiments, the reduction in carbon intensity can result from processes used to produce such a material having a lower energy cost compared to traditional kiln firing at temperatures exceeding 1000° C. to activate the calcium silicate material.

In additional embodiments, the technology and methods disclosed herein reduce energy consumption during the production of cementitious materials. In certain embodiments, the technology and methods disclosed herein bypass conventional firing processes that typically require heating kilns to elevated temperatures (e.g., exceeding 1000° C.), which can be one of the most highly energy-intensive operations in cement manufacturing. Instead of using a high temperature firing process to activate the cementitious material, the technology and methods disclosed herein employ mechanical activation methods to produce cementitious materials, thereby providing a more energy-efficient production pathway. In further embodiments, the technology and methods disclosed herein reduce or eliminate the need for certain additives (e.g., aluminum oxide) that are traditionally used to enhance thermal activation. Such additives are typically included to facilitate (e.g., improve) thermal activation, but can result in cementitious materials with reduced resistance to chemical attack and/or other undesirable properties in the cementitious material. By reducing or eliminating these additives, embodiments of the technology can yield cementitious materials with enhanced chemical resistance properties and/or other properties.

In further embodiments, the technology and methods disclosed herein result in low calcium content hydraulically active cement. In certain embodiments, the properties of the hydraulically active cement depend on a crystallinity of the cementitious materials, a grain size of the cementitious materials, a composition (calcium content, ratio of calcium to silicon, presence or absence of residual or additive species, etc.) of the cementitious materials, a surface property of the cementitious material (or materials thereof such as a surface functionalization, surface termination, etc.), and/or other aspects of the cementitious material can modulate the hydraulic activity. In some embodiments, the cementitious material have a compressive strength exceeding about 20 MPa after about 7 days of curing. In preferred embodiments, the cementitious material has a compressive strength exceeding about 28 MPa after about 28 days of curing. In yet further preferred embodiments, the cementitious material has a compressive strength exceeding about 35 MPa after about 90 days of curing. In additional preferred embodiments, the cementitious material has a compressive strength exceeding about 5 MPa after about 7 days of curing.

In additional embodiments, the technology and methods disclosed herein enhance the reactivity of the cementitious material through mechanical processing methods. For example, aspects and methods of the technology disclosed herein that include grinding the silicon oxide precursors result in ground silicon oxide precursors that have reduced crystallinity and/or particle size (e.g., as relative to unground silicon oxide), which can increase the reactivity and/or reactive surface area. In certain embodiments, the enhanced reactivity and/or surface area facilitates more efficient activation with calcium oxide, thereby, for example, leading to reduced curing times and/or improved mechanical properties of the resultant cement. In preferred embodiments, the increased reactivity allows for the use of reduced calcium-to-silica ratios while maintaining desired performance characteristics, which can provide additional benefits in terms of resource utilization and environmental impact.

In further embodiments, the technology and methods disclosed herein achieve reduced carbon emissions, as compared to, for example, conventional cement production methods. In certain embodiments, by implementing processes that bypass traditional firing methods for calcium-silica mixture activation and allowing for the production of cementitious materials with substoichiometric calcium relative to silicon content, embodiments of the technology result in pathways for lower-carbon cement production compared to traditional thermal approaches. In some embodiments, the reduction in carbon emissions are particularly significant given the substantial contribution of conventional cement production to global carbon dioxide emissions.

The embodiments set forth above are non-limiting and further advantages may be provided by the technology and method disclosed herein.

### 4. Method

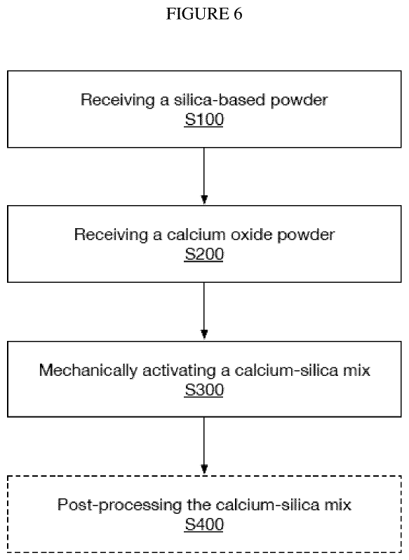

As shown in FIG. 6, embodiments of the methods disclosed herein comprise: receiving a silica-based powder S100; receiving a calcium oxide powder S200; activating the calcium-silica mixture S300; optionally post-processing the calcium-silica mixture S400; and/or other suitable steps.

In preferred embodiments, the methods disclosed herein produce a hydraulic cementitious material. In further embodiments, the methods additionally or alternatively produce a non-hydraulic cementitious material and/or other suitable material. The methods disclosed herein can be performed continuously and/or in batches. In addition, the methods disclosed herein can be performed by industrial facility/factory, mills, and/or any other facility.

In preferred embodiments, the cementitious material is used to form a cement with a compressive strength exceeding about 5 MPa after about 28 days of curing. For instance, the cementitious materials can be used for concrete, mortar, plaster, hydraulic cement, stucco, grout, screeds, insulation, fire protection, acid mine drainage remediation, sealants, agriculture (as a source of calcium and silicon), as a food additive, as a phosphate or other runoff trap, and/or for other suitable purposes.

Receiving a silicon oxide material S100 functions to obtain a silica and/or silicate material (e.g., SiOₓ, SiO₂, etc.) for producing the cementitious material. S100 can be performed continuously, on-demand, at set intervals, periodically, sporadically, based on stock levels, as per production schedules, upon delivery, after precursor preparation, upon quality assurance approval, and/or any other timing.

In some embodiments, S100 comprises receiving (e.g., acquiring) pre-processed (e.g., activated) silica-based material (e.g., from a third party, as mined, from storage, etc.) where the pre-processed silicon oxide, in preferred embodiments, has properties substantially identical to those described for a processed or activated silicon oxide as described below, processing a silicon oxide precursor material (e.g., to achieve the material properties of interest), and/or other suitable steps.

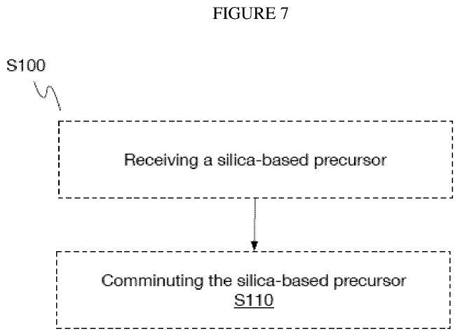

As shown for example in FIG. 7, in certain embodiments, S100 comprises comminuting a silicon oxide precursor S110. In some embodiments, S110 functions to change the geometry of the silica-based precursor into particulate matter with a target particle size, particle size distribution, crystallinity, and/or other suitable property(s) (e.g., morphology, silicon to oxygen content, etc.). Examples of silicon oxide materials (e.g., silicon oxide precursors, silicon oxide material precursors, as-received silicon oxide materials, etc.) include silica, such as quartz, sandstone, fly ash, fumed silica, silica fumes, silica gels, sand, fiberglass, silica beads, pyrogenic silica, diatomaceous earth, and/or any other silica-based materials. In some embodiments, the aforementioned silicon oxide precursors are used without comminution (e.g., when one or more properties of the as-received silicon oxide material match have target properties).

The silicon oxide powder can be particulate matter, granules, grains, shards, and/or any other form. The target size of silicon oxide particulates (e.g., activated silicon oxide material, post comminution, post-grinding silicon oxide material, etc.) is preferably between 0.01-10 micrometers or any range or value therebetween (e.g., 0.01 μm, 0.05 μm, 0.1 μm, 0.2 μm, 0.3 μm, 0.4 μm, 0.5 μm, 0.6 μm, 0.7 μm, 0.8 μm, 0.9 μm, 1 μm, 1.1 μm, 1.2 μm, 1.5 μm, 2 μm, 3 μm, 4 μm, 5 μm, 6 μm, 7 μm, 8 μm, 9 μm, 10 μm, etc. as measured by, for example, laser diffraction methods). In some embodiments, the silicon oxide particles are, preferably, smaller than particle sizes typically used for cement. In certain embodiments, the aforementioned particle sizes can ensure that the resultant calcium silicate is amorphous and/or nanocrystalline. The particle size is preferably uniform (e.g., has a low span value such as less than 0.5; has a low coefficient of variation such as less than 5%, less than 10%, etc.; a low polydispersity index such as less than 0.2; etc.). However, in other embodiments, the particle size is polydisperse and/or has large variance. A certain target particle size (e.g., D50 particle size) for the silicon oxide material can be chosen based on the resulting properties of cement (e.g. strength, setting time, curing time, etc.) formed from cementitious material. Alternatively, a target particle size can be chosen (e.g., based on properties for activation of the cementitious material). In certain embodiments, a readily activated cementitious material is formed using 40 nm silicon oxide particles. In other embodiments, silicon oxide particles have a size greater than about 100 nm and results in a cementitious material that does not readily set. In further embodiments, using silicon oxide particles with a size less than 10 nm resulted in a cementitious material slurry that had poor handling properties (e.g., based on the rheological properties). In some embodiments, the geometry of the silicon oxide particulates is irregularly shaped, spheres, shards, rods, fragments, or flakes. Generally, the silicon oxide particulates can have any suitable geometry. In preferred embodiments, the crystallinity of the silicon oxide particulates is amorphous or nanocrystalline. For example, a crystal domain size (as measured using, for example, XRD or other suitable measurement technique) can be between 1 and 100 nm.

In certain embodiments, comminuting comprises grinding, milling, pulverizing, crushing and/or any other suitable processes (e.g., that can transform the silicon oxide precursor into smaller particulates) including wet (e.g., in the presence of a solvent) and/or dry (e.g., excluding solvent) processing.

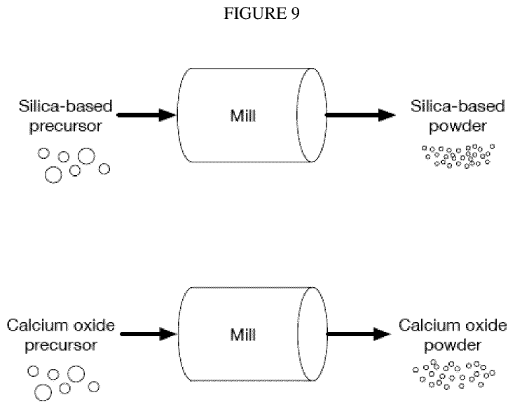

In some embodiments, S110 is performed, as shown for example in FIG. 9, by mills, grinders, and/or any other suitable comminutor. The comminution chamber (e.g., milling chamber, grinding chamber, etc.) can be made of carbon steel, stainless steel, alloy steel, high-carbon steel, or cast iron. Generally, the comminution chamber can be made of any suitable material (e.g., with hardness that exceeds that of the silicon oxide precursor(s)). In some embodiments that use a mill, the mill can be operated at, for example, RPMs of 200, 300, 350, 400, 450, 500, 550, 600, 700, 800, 900, 1000, 1200, 1400, 1600, 1800, 2000, 2500 rotations per minute, and/or values or ranges therebetween. In certain embodiments, the speed and direction of mill is consistent throughout the milling process and/or can be modified throughout the process. In some embodiments, the comminution time (e.g., time actively spent comminuting) is between 0.5 min and 6 hours or any range or value therebetween (e.g., 1 min, 5 min, 10 min, 20 min, 25 min, 30 min, 45 min, 1 hour, 2 hours, 3 hours, etc.). In other embodiments, the comminution time is less than 0.5 hours or greater than 6 hours.

In certain embodiments, the comminution process comprises dynamically controlling one or more milling parameters over time. For example, in some embodiments, S110 comprises initiating comminution at a first rotational speed and subsequently increasing or decreasing the rotational speed according to a predetermined schedule, stepwise profile, or feedback-based control. In further embodiments, the mill is operated at a relatively low rotational speed during an initial period to promote gradual particle fracture and reduce excessive agglomeration, followed by one or more increases in rotational speed to enhance further size reduction and mechanical activation. Additionally or alternatively, the direction of rotation of the mill is periodically reversed during comminution, such as reversing the rotation direction at regular time intervals (e.g., every 15 minutes, 30 minutes, 1 hour, or other suitable interval), to promote more uniform milling, reduce dead zones, and improve mixing of the silicon oxide precursor. The duration of each rotational speed, direction, or operating condition can be fixed, variable, or adaptively adjusted based on time, energy input, temperature, particle size measurements, or other process parameters. However, the comminution and/or milling parameters can be otherwise controlled.

In certain embodiments, the mills comprise media mills (e.g., rotary drum mill, ball mill, rotary ball mill, planetary ball mill, stirred medium mill, rod mill, tube mill, semi-autogenous mill, vibratory mill, etc.). In some embodiments, the grinding media used in media mills can be made of carbon steel, stainless steel, chrome steel, forged steel, alumina, zirconia, glass, polyurethane, or any other suitable material (e.g., with hardness that exceeds that of the silicon oxide precursor(s)). The grinding media can be any size or geometry (e.g., spherical, spheroidal, cylindrical, rod-like, elliptical, cubic, prismatic, disc-like, polyhedral, etc.). The ratio of grinding media to silicon oxide precursor by weight or volume can be, for example, 1:1, 2:1, 3:1, 5:1, 10:1, 20:1, 25:1, 30:1, 40:1, 50:1 or any suitable ratio.

In certain embodiments, the mills comprise mechanical mills or grinders (e.g., vertical roller mill, hammer mill, attrition mill, cage mill, roller press, jet mill, impact mill, jaw crusher, pulverizer, disc mill, etc.). The rotors, hammers, grinding plates, or plates of the mechanical mills can be made of high-carbon steel, alloy steel, chromium steel, manganese steel, tungsten carbine, cast iron, alumina, zirconia, or any other suitable material.

In certain embodiments, S110 comprises loading a planetary ball mill with silica chunks and stainless-steel balls at about a 10:1 ratio by volume, and operating the planetary ball mill at about 500 RPM for 0.5 to 6 hours. In further embodiments, S110 comprises continuously operating a vibratory mill loaded with alloy steel balls and quartz fragments until silicon oxide particles pass through a 50-nanometer sieve. In yet further embodiments, S110 comprises operating a hammer mill with carbon steel components to grind fly ash granules into particulate matter (e.g., until an average particle size of about 30 nanometers is achieved).

In certain embodiments, S110 comprises maintaining the comminutor and/or mixture under a threshold temperature (e.g., to hinder or prevent formation of hot spots, to prevent sintering, burning etc.). The mixture is preferably maintained at a temperature less than about 800° C., as temperatures greater than 800° C. can result in phase changes and/or sintering of the material (which may result in reduced reactivity of the resulting cementitious material). For example, the comminutor and/or mixture can be maintained at a temperature below 50° C., 60° C., 70° C., 80° C., 90° C., 100° C., 200° C., 300° C., 400° C., 500° C., 600° C., 700° C., 800° C., or any value and/or range therebetween. However, in other embodiments (e.g., based on a particle size of the silicon oxide particles), temperatures greater than about 800° C. may be permissible. In some embodiments, to maintain the target temperature, the comminutor is cooled. Cooling can be achieved, for example, using water jackets, cooling coils, fans, refrigeration, cryogenic agents (e.g., liquid nitrogen, liquid helium, etc.), heat exchangers, exhaust ventilation, and/or any other suitable cooling mechanism.

In some embodiments, the comminution process can further include monitoring the particle size of the silicon oxide material during and/or after comminution to determine whether a target particle size or particle size distribution has been achieved. Particle size monitoring can be performed continuously, periodically, intermittently, or at predefined time intervals during S110. For example, samples of the comminuted silicon oxide material can be analyzed using one or more particle size measurement techniques, including sieving, laser diffraction, dynamic light scattering, sedimentation analysis, microscopy (e.g., optical microscopy, scanning electron microscopy, transmission electron microscopy), image analysis, or any other suitable method. The particle size can be monitored within the comminution chamber, external the comminution chamber (e.g., silicon oxide can be extracted from the comminution chamber and monitored or analyzed), and/or can otherwise be monitored. Based on the monitored particle size, the comminution process can be halted, continued, or adjusted (e.g., by modifying rotational speed, comminution time, grinding media loading, or milling direction) to achieve a desired particle size, particle size distribution, or crystallinity. In further embodiments, comminution is terminated when a measured D50 particle size falls within a predetermined target range, such as between about 0.1 μm and about 10 μm, or when a threshold fraction of particles is below a specified size. However, the material can be otherwise tested, assessed, and/or monitored.

However, receiving a silica-based powder S100 can be otherwise performed.

In certain embodiments, receiving a calcium oxide powder S200 functions to obtain a calcium-containing material that can be used in producing the cementitious material. S200 can be performed continuously, on-demand, at set intervals, periodically, sporadically, based on stock levels, per production schedules, upon delivery, after precursor preparation, or upon quality assurance approval, and/or at any other time.

Receiving a calcium oxide powder S200 can include receiving a pre-processed (e.g., decomposed, milled, etc. such as having target chemical composition, morphology, etc.) calcium-based material (e.g., from a third party, as mined, etc.), or processing a calcium-based precursor material (e.g., to achieve the material properties of interest such as particle size, geometry, chemical composition, etc.).

The calcium oxide powder can be particulate matter, granules, grains, shards, flakes, and/or any other form. The size of calcium oxide particulates (e.g., as received, processed, etc.) can be between about 1-1000 microns or any range or value therebetween (e.g. 1 micron, 10 microns, 20 microns, 50 microns, 100 microns, 200 microns, 500 microns, 1000 microns). The size can alternatively be less than about 1 micron or greater than about 1000 microns. In certain embodiments, the calcium oxide has a particle size between about 10 and about 100 microns. Such sizes may result in readily activated cementitious material (with favorable rheologic properties). The particle size can be uniform (e.g., have a uniformity as described above for silicon oxide particles), highly variable, and/or have any other distribution. The geometry of calcium oxide particulates can be irregularly shaped, spheroidal, shard-like, rod-like, fragmented, flake-like, and/or any suitable geometry.

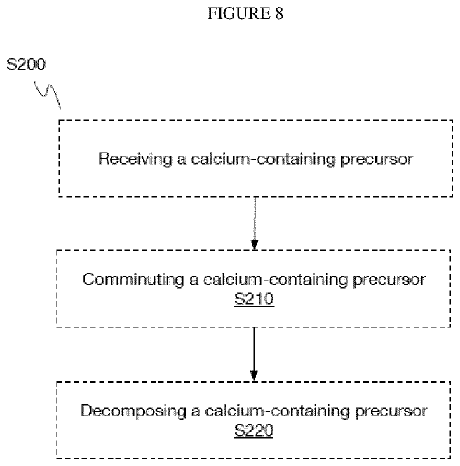

In certain embodiments (as shown for example in FIG. 8), receiving a calcium oxide powder S200 comprises comminuting a calcium-containing precursor S210.

Comminuting a calcium-containing precursor S210 can function to change the morphology of the calcium-containing precursor into particulate matter with a target particle size. S210 can be conducted continuously, periodically, intermittently, at intervals, or sporadically, until the calcium-containing precursor particulates become the predetermined target size. S210 can occur contemporaneously (e.g., simultaneously, concurrently with, etc.), synchronously, and/or asynchronously of S110 or S300, and/or with any other timing.

The calcium-containing precursor can be limestone, chalk, lime, slaked lime, gypsum, plaster of Paris, calcite, aragonite, vaterite, ikaite, monohydrocalcite, portlandite, afwillite, larnite, spurrite, brownmillerite, anhydrite, selenite, bassanite, calcium oxide, calcium hydroxide, calcium sulfate, calcium carbonate, and/or any other calcium-containing material. In some embodiments(e.g., prior to comminution), the calcium-containing precursor can be blocks, chunks, granules, pebbles, and/or any other geometry. However, the calcium-containing precursors can be received in a form already having the target properties (e.g., size, crystallinity, morphology, etc.), rather than be changed by comminution.

In certain embodiments, S210 is performed by mills or grinders (as shown for example in FIG. 9). In certain such embodiments, the mills or grinders have the same properties or different properties from the mills and grinders described in S110. S210 can be performed in a manner as described in S100 (e.g., in S110). Comminution parameters (e.g., time, speed, milling medium, comminution fill ratio, ratio of comminution medium to material to be milled, etc.) used in S210 can be the same and/or different from S110 (e.g., same parameters can be used to grind calcium-containing materials as silicon oxide materials, different parameters can be used for the materials but the parameters can be selected from within the same range of parameters, etc.).

In certain embodiments, S210 comprises loading a rotary ball mill with stainless steel balls and limestone aggregate at about a 10:1 ratio by weight and operating the rotary ball mill at about 300 RPM for 0.5 to 6 hours. In further embodiments, S210 comprises operating a carbon steel vertical roller mill with gypsum chunks and milling until all material is ground to a target particle size (e.g., separated out of the mill from the air flow). In yet further embodiments, S210 comprises loading a stirred media mill with alloy steel balls and calcium oxide particulates at about a 5:1 ratio by weight and operating the stirred media mill at about 500 RPM for 0.5 to 6 hours.

In certain embodiments, the comminuted calcium-containing precursor exhibits target physical properties indicative of effective activation and suitability for subsequent processing. For example, when the calcium-containing precursor includes calcium carbonate or calcium sulfate, comminution can produce particulates having a characteristic particle size (e.g., D50, average, etc.) between about 10 and about 100 μm (e.g., about 10 μm, 20 μm, 30 μm, 40 μm, 50 μm, 60 μm, 70 μm, 80 μm, 90 μm, 100 μm, or any suitable value and/or range therebetween). In further embodiments, the particulates have a D90 of less than about 150 μm or less than about 100 μm. In still further embodiments, the comminuted calcium-containing precursor is spherical or, preferably, exhibits irregular or fractured particle morphologies, having high specific surface area (e.g., greater than about 1 m²/g, greater than about 5 m²/g, or greater than about 10 m²/g), and/or reduced crystal size relative to the precursor prior to comminution. When the calcium-containing precursor includes calcium oxide, comminution can produce fine calcium oxide particulates having a characteristic particle size of less than about 50 μm, preferably less than about 20 μm, with high surface reactivity suitable for subsequent reaction with silicon oxide. When the calcium-containing precursor includes calcium sulfate (e.g., gypsum, bassanite, or anhydrite), comminution can yield plate-like or irregular particulates with reduced aspect ratio and enhanced dispersion behavior in cementitious mixtures.

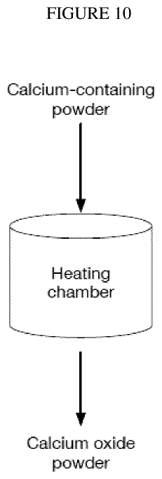

In certain embodiments (e.g., when the calcium-containing material as received is not calcium oxide), S200 can include decomposing a calcium-containing precursor S220. S220 can function to chemically alter the calcium-containing precursor into calcium oxide (and/or calcium hydroxide). S220 can be performed after receiving the calcium-containing precursor, either before, during, or after S210. As shown for example in FIG. 10, S220 can be performed using a kiln (e.g., rotary kilns, vertical shaft kilns, fluidized bed kilns, etc.), thermal reactor, comminution chamber (e.g., a grinder, mill, etc. as used in S110 or S210), and/or any other device. The temperature for decomposing can vary depending on the calcium-containing precursor. In certain embodiments, CaCO₃ is decomposed into CaO and CO₂ at a temperature above about 900° C. (e.g., about 900° C., 950° C., 1000° C., 1100° C., 1200° C., 1500° C., values or ranges therebetween, etc.). In further embodiments, CaSO₄ is decomposed into CaO and SO₃ at temperatures above about 1000° C. (e.g., about 1000° C., 1100° C., 1200° C., 1500° C., 2000° C. values or ranges therebetween, etc.). However, other decomposition temperatures can be used. In certain embodiments, decomposing is performed during comminution of the calcium-containing precursor. In certain such embodiments, during comminution, the mill, comminution device, and/or calcium-containing precursor is heated to a decomposition temperature. Heating can be provided by external heating of the mill (e.g., electric resistance heating, induction heating, a heated milling chamber, combustion, etc.) and/or by self-heating (e.g., resulting from frictional, impact, shear forces, etc. generated during high-energy comminution).

In certain embodiments, S220 can further include assessing the calcium-containing precursor during decomposition to verify conversion and/or to prevent over-burning, under-burning, or undesirable phase formation. Assessment can be performed continuously, periodically, intermittently, or at predefined intervals during thermal treatment. For example, one or more temperature sensors, thermocouples, infrared sensors, or thermal imaging devices can be used to monitor the temperature of the precursor and/or the kiln environment to ensure the precursor is maintained within a target temperature range. Additionally or alternatively, the chemical state of the calcium-containing precursor can be evaluated using one or more analytical techniques, including acid reactivity testing, weight loss analysis, off-gas monitoring, X-ray diffraction (XRD), thermogravimetric analysis (TGA), differential scanning calorimetry (DSC), or combinations thereof. Based on the assessment results, one or more decomposition parameters—such as temperature, residence time, heating rate, or atmosphere—can be adjusted, extended, or terminated to achieve a desired degree of decomposition while minimizing sintering, melting, or loss of reactivity. However, the calcium-containing precursor can be otherwise monitored. The decomposition time (e.g., the amount of time the precursor is maintained at the decomposition temperature) can be between about 1-12 hours or any range or value therebetween. However, the decomposition time can be less than about 1 hour or greater than about 12 hours.

In certain embodiments, decomposition comprises a dehydration step (e.g., where the temperature is maintained first at the dehydration step for a first amount of time before decomposition temperature is maintained). In further embodiments, the dehydration temperature is between about 100° C. and about 500° C. or any range or value therebetween. The dehydration temperature can, however, be less than about 100° C. or greater than about 500° C.

In certain embodiments, S220 comprises loading a rotary kiln with comminuted calcium carbonate, heating the kiln to 900° C., and maintaining the kiln at about 900° C. for 12 hours. In further embodiments, S220 comprises, prior to S110, loading a vertical shaft kiln with gypsum aggregate, heating the kiln to about 1200° C., and maintaining the kiln at about 1200° C. for at least 1 hour. In yet further embodiments, S220 comprises loading a kiln with limestone, heating the kiln to about 1000° C., and maintaining the kiln at about 1000° C. for 8 hours.

However, receiving a calcium oxide powder S200 may be otherwise performed.

Without wishing to be bound by theory, it is thought that activating the calcium oxide and silicon oxide mixture S300 functions to mix silicon oxide powder and calcium oxide (where calcium oxide is inclusive of any combination or sub-combination of calcium oxides, calcium carbonates, and calcium hydroxides) powder and induce a chemical reaction (e.g., via agitation, collision, shearing, friction, and/or any other suitable mechanical activation methods). In certain preferred embodiments, S300 results in a cementitious material. In further embodiments, the activated material may not be cementitious until after subsequent processing (e.g., in S400). In certain preferred embodiments, S300 comprises mechanically activating the calcium oxide-silicon oxide mixture (e.g., initiates a chemical reaction between the calcium oxide and silicon oxide via mechanical phenomena). However, S300 can additionally or alternatively include chemical activation, thermal activation, optical activation, electrical activation, and/or other suitable activation process(s).

In certain embodiments, S300 occurs after S100 and S200. In other embodiments, S300 is performed contemporaneously and/or simultaneously with one or both of S100 and/or S200. In further embodiments, the mechanical activation occurs continuously, intermittently, sporadically, periodically, and/or with any other temporal pattern.

Mechanically activating can include mixing, agitating, crushing, shearing, reacting, and/or any other mechanical activation methods. An exemplary reaction that can be performed or achieved during S300 is CaO+SiO₂→CaSiO₃. Other similar reactions with different stoichiometries of Ca:Si can similarly be performed. The reaction can generate heat, heat can be produced during the comminution process (e.g., from friction), heat can be supplied during S300 (e.g., to initiate a reaction), and/or heat may otherwise be formed. Heat generated during S300 can be recovered and used in other systems (e.g., kilns, thermal reactors, used in step S410, etc.), and/or any other systems.

In certain preferred embodiments, the mixture to be activated is a mixture of calcium oxide (e.g., from S200) and silicon oxide (e.g., from S100). The ratio (e.g., by weight, by stoichiometry, etc.) of silicon oxide to calcium oxide is preferably about 5:1, 4:1, 3:1, 2:1, 1:1, 1:2, 1:3, 1:4, 1:5, and/or a value or range therebetween. In some embodiments, the activated mixture is substoichiometric in calcium, such that the silicon oxide to calcium oxide ratio is greater than about 1:1 (e.g., about 2:1 to about 20:1). These low-calcium compositions can promote the formation of low-calcium calcium silicate phases and/or amorphous or nanocrystalline calcium silicate hydrates.

In some embodiments, the mixture comprises one or more additives. The additives can function to modify a property of the mixture prior to and/or during activation (e.g., rheology, thermal transport, etc.), modify a property of the resulting cementitious material (e.g., compressive strength, chemical resistance, etc.), and/or can otherwise modify the mixture or resulting activated mixture. Exemplary additives include, but are not limited to: pozzolanic additives (e.g. fly ash, silica fume, metakaolin, slag), aluminosilicates (e.g. kaolin, illite, montmorillonite, etc.), fibers (e.g. steel fibers, polypropylene fibers, glass fibers, carbon fibers, etc.), aluminates, nano-additives (e.g. nano titanium dioxide particles, carbon nanotubes, graphene oxide), gypsum, plasticizers, alkali-based additives, alkaline substances, corrosion inhibitors (e.g. calcium nitrite, amines, phosphates), and/or any other additives. In some embodiments, the additives are added after the mixture has been activated (e.g., during S400). In some embodiments, the additives are added prior to (e.g. co-milled with the precursors during S110 or S210) and/or during activation of the mixture. The additives are preferably between about 0.01 wt % and about 10 wt % of the cementitious material (e.g., about 0.01 wt %, 0.05 wt %, 0.1 wt % 0.5 wt % 1 wt %, 2 wt %, 3 wt %, 4 wt %, 5 wt %, 6 wt %, 7 wt %, 8 wt %, 9 wt %, 10 wt %, or any value and/or range therebetween). The 10 wt % refers to a total wt % of additives and/or a wt % of a specific additive (where each additive can contribute up to about 10 wt % each). However, in some embodiments, the additives make up greater than about 10 wt % of the cementitious material.

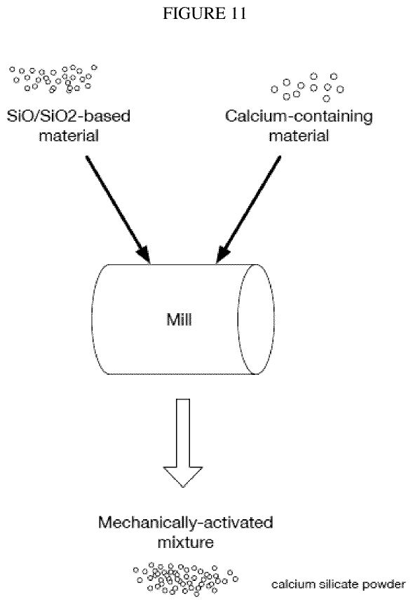

As shown for example in FIG. 11, S300 is preferably performed using a comminutor (e.g., mill, media mills, mechanical mills, grinders, mixers, ball mill, etc.). However, additionally or alternatively other activation equipment can be used (e.g., a kiln or other thermal reactor can be used for portions of S300 such as to provide thermal activation prior to or subsequent to mechanical activation).

The comminutor (and/or comminution parameters used therewith) used for mechanically activating the mix can be the same and/or different equipment from that used in S110 and S210. In certain embodiments, the calcium oxide and silicon oxide are activated using a ball mill, vertical roller mill, grinding roll, attritor mill, jet mill, rotary mill, stirred media mill, vibratory mill, high-shear mixer, hammer mill, disc mill, roller press, pulverizer, and/or any other comminutor (e.g., mechanical activation equipment). The comminutor is preferably operated at between about 100 and about 800 rotations per minute (RPM). In some examples where greater than about 800 RPM was used, excess heat was theorized to occur resulting in reduced reactivity (e.g., lower compressive strength after a curing time as compared to cementitious materials formed using lower rpm) of the cementitious material (theorized to be a result of particle sintering). In some examples where less than about 100 RPM was used, insufficient mechanical phenomena were theorized to occur and thus little or no activation was observed. However, it may be possible to use less than about 100 RPM (e.g., with concomitant heating of the comminutor, by inclusion of one or more additive, etc.) and/or greater than about 800 RPM (e.g., with concomitant cooling of the comminutor, by inclusion of one or more additive, etc.). In some embodiments, mechanically activating the calcium oxide and silicon oxide with milling speeds that exceeded about 600 RPM results in further reduction in particle size. In certain embodiments, co-milling at a milling rate of at least 200 RPM enables the mechanochemical reaction. In certain embodiments, the milling speeds used in S300 are lower than the speeds used for comminution (e.g., in S110 and S210).

The speed (and direction) of comminution can be consistent throughout the milling process and/or can be modified throughout the process. In certain embodiments, S300 comprises starting at slow speeds and increasing the speed during mechanical activation until a target milling speed (e.g., an activation speed, activation RPM, etc.) is achieved. In further embodiments, S300 comprises intermittent milling (e.g., periods of active comminution, agitation, etc. interspersed with periods of rest which can facilitate thermal equilibration and a reduced risk of hot spot formation). In yet further embodiments, S300 comprises changing rotation direction.

In certain embodiments, S300 comprises maintaining the comminutor and/or mixture under a threshold temperature (e.g., to hinder or prevent formation of hot spots where sintering, burning, unwanted chemical reactions, etc.). The mixture is preferably maintained at a temperature less than about 800° C. as temperatures greater than 800° C. may result in phase changes and/or sintering of the material (often resulting in reduced reactivity of the resulting cementitious material). However, in some embodiments (e.g., based on a particle size of the silicon oxide particles), temperatures greater than 800° C. may be permissible. In some embodiments, to maintain the target temperature, the comminutor is cooled. Cooling can be achieved, for example, using water jackets, cooling coils, fans, refrigeration, cryogenic agents (e.g., liquid nitrogen, liquid helium, etc.), heat exchangers, exhaust ventilation, and/or any other suitable cooling mechanism.

S300 is preferably performed for a threshold comminution time (e.g., an amount time spent actively comminuting, milling, etc. the mixture). The threshold comminution time is preferably between about 0.5 min and about 6 hours and/or any range or value therebetween (e.g., about 1 hour, 2 hours, 3 hours, etc.). The comminution time can alternatively be less than about 0.5 min or greater than about 6 hours. However, any suitable amount of time that leads to mechanochemical activation of the materials can be used. In certain embodiments, S300 is performed until the mixture is sufficiently reacted (e.g., based on measurements of samples using X-ray diffraction, Fourier-transform infrared spectroscopy, Raman spectroscopy, etc. taken after different comminution times). In further embodiments, S300 is performed for the threshold comminution time.

In some embodiments, S300 further comprises assessing reaction progress of the calcium oxide-silicon oxide mixture during mechanical activation. Reaction progress can be monitored continuously, periodically, intermittently, or at predefined time intervals (e.g., about every 5 minutes, 10 minutes, 20 minutes, 30 minutes, 1 hour, or any suitable interval). For example, samples of the mechanically activated mixture can be withdrawn from the comminutor and analyzed to determine the extent of reaction between calcium oxide and silicon oxide. Assessment techniques can include X-ray diffraction (XRD) to detect formation of calcium silicate phases or reduction of precursor phases, Fourier-transform infrared spectroscopy (FTIR) or Raman spectroscopy to monitor changes in bonding environments, calorimetric measurements to detect reaction heat, particle size analysis to detect activation-induced refinement, surface area measurements (e.g., BET analysis), chemical titration or acid reactivity testing, and/or any other suitable analytical technique. Based on the assessed reaction progress, one or more activation parameters—such as comminution time, rotational speed, milling direction, temperature control, or additive introduction—can be adjusted, extended, or terminated to achieve a desired degree of mechanical activation or phase formation while limiting over-activation, sintering, or loss of reactivity. However, the reaction progress can be otherwise assessed.

In certain embodiments, S300 comprises continuously agitating about a 3:1 weight ratio of silicon oxide (e.g., from S100) to calcium oxide (e.g., from S200) in stirred media mill loaded with alloy steel media at about 200 RPM for 0.5 to 6 hours.

In certain embodiments where calcium oxide and/or calcium hydroxide and silicon oxide are mechanically reacted, the particle sizes of the calcium oxide and silicon oxide are selected to promote intimate mixing and efficient solid-state reaction. In some embodiments, the silicon oxide is milled to a characteristic particle size between about 0.01 μm and about 10 μm (e.g., about 0.01 μm, 0.05 μm, 0.1 μm, 0.2 μm, 0.3 μm, 0.5 μm, 0.7 μm, 1 μm, 2 μm, 3 μm, 5 μm, 7 μm, 10 μm, and/or any value or range therebetween). In certain embodiments, the calcium oxide is milled to a characteristic particle size between about 0.1 μm and about 20 μm (e.g., about 0.1 μm, 0.2 μm, 0.5 μm, 1 μm, 2 μm, 5 μm, 7 μm, 10 μm, 15 μm, 20 μm, and/or any value or range therebetween). In some embodiments, the calcium oxide and silicon oxide have substantially similar particle sizes prior to mechanical activation. Reducing the particle sizes of both reactants can increase contact area, reduce diffusion length scales, suppress formation of unreacted lime, improve reaction uniformity, and/or enhance formation of amorphous or nanocrystalline calcium silicate phases during mechanical activation.

However, activating the calcium oxide and silicon oxide mixture S300 may be otherwise performed.

Optionally post-processing the activated mixture S400 functions to refine and prepare the activated mixture (e.g., from S300) for further use in cement production and/or concrete manufacturing. S400 is preferably performed after S300. In some other embodiments, S400 is performed during (e.g., contemporaneously with) S300.

S400 can include drying, filtering (e.g., sieving), granulation, chemical treatment (e.g., to ensure consistency, quality, performance metrics, etc. before further use in subsequent steps), and/or other suitable processes. Drying can function to remove residual moisture (e.g., using an oven, rotary dryer, fluidized bed, etc.), which can be beneficial as excess moisture in the cementitious material can cause clumping and/or interfere with curing of cement. Sieving can function to ensure the cementitious material particle size is uniform, which may be beneficial for reducing defects/voids in resultant cement and/or for resulting in predictable and uniform hydration of the mixture. Granulation can function to produce larger granules of the cementitious material (e.g., from S300), which may be beneficial for reducing dust and/or improving handling of product.

In some embodiments, optionally post-processing the activated mixture S400 comprises introducing an additive with or into the activated mixture S410; washing the activated mixture S420; making concrete S430; testing the activated mixture S440.

Introducing an additive with or into the cementitious material S410 can function to alter or modify the properties of the calcium-silica mixes or the resulting cement. The activated mixture can be blended with other materials, for example, to modify cement properties (e.g., compressive strength, setting time, durability, etc.). Any suitable additive as described in S300 can be added in S410. In some embodiments, S410 can be performed prior to and/or concurrently with S300 (e.g., where one or more additives can act as a grinding aid).

In certain embodiments, S410 comprises heating the additive with the activated mixture. In certain such embodiments, the temperature is preferably between about 300° C.-1500° C. or any range or value therebetween (e.g., about 400° C., 800° C., 1000° C.). The heating can occur for 15 minutes, 30 minutes, 1 hour, 2 hours, 5 hours, 10 hours, or any suitable amount of time. S410 can be performed by a thermal reactor, kiln, and/or any other equipment.

In certain embodiments, S410 comprises performing alkali fusion with the activated mixture, which can enhance the reactivity of the cementitious material by introducing an alkaline medium (e.g., sodium oxide, potassium oxide, lithium oxide, rubidium oxide, beryllium oxide, magnesium oxide, strontium oxide, barium oxide, etc. where the ultimate minerology can be a more complex mixture of the existing species rather than separate oxide phases). The alkaline substances can be introduced, for example, using sodium hydroxide, potassium hydroxide, sodium silicate, potassium silicate, lithium silicate, rubidium silicate, cesium silicate, and/or any other alkaline substances. The composition of alkaline substance in the cementitious material is preferably between about 0.1% by weight and about 50% by weight or any range or value therebetween (e.g., about 0.5% by weight, 1% by weight, 5% by weight, 10% by weight, 20% by weight, 25% by weight). In certain embodiments, the process comprises comminuting the mixture after alkali fusion (e.g., to achieve a target particle size).

Washing the activated material S420 functions to remove soluble impurities. S420 can be performed by a washing system, fluidized bed, liquid phase extraction method, filters, and/or any other washing method. S420 can include washing using water and/or other solvents (e.g., ethers, alcohols, ketones, etc.) to separate impurities of soluble components in the solvent. S420 can involve a series of rinsing, filtration, and decanting steps.

In some embodiments, S420 comprises washing the activated material using a rotary washer, drum washer, screw washer, or similar continuous or batch washing apparatus. For example, the activated material can be introduced into a rotary washer where it is contacted with water and/or a solvent while being agitated to promote dissolution and removal of soluble impurities. In other embodiments, S420 can include hydrocyclones, slurry separation systems, or centrifugal separators configured to separate fine particles or dissolved species from the activated material based on density, particle size, or solubility differences. However, any suitable equipment can be utilized.

In some embodiments, S420 comprises forming a slurry of the activated material and a washing fluid, followed by one or more slurry separation processes such as sedimentation, filtration, centrifugation, or decanting. The slurry separation process can be repeated multiple times to progressively reduce impurity concentration. For example, a multi-stage washing process can be employed in which the activated material is sequentially washed, separated, and re-suspended (with fresh solvent).

During S420, one or more washing parameters can be selected or adjusted to ensure effective removal of impurities. Such parameters can include solvent quality (e.g., deionized water, softened water, recycled process water, etc.), washing fluid temperature, solvent concentration, liquid-to-solid ratio, agitation intensity, residence time, and total washing duration. In some embodiments, washing can be performed at elevated temperatures to enhance solubility of impurities, while in other embodiments washing can be performed at ambient conditions (e.g., to reduce energy consumption).

In some embodiments, the washing process is monitored and evaluated during and/or after S420 to determine washing effectiveness. Monitoring can include periodic sampling of the washing fluid and/or washed material to test for residual soluble species, ionic content, pH, electrical conductivity, or chemical composition. Based on the monitoring results, washing parameters can be adjusted, additional washing cycles can be performed, or washing can be terminated once impurity levels fall below a predetermined threshold.

In certain embodiments, making concrete S430 produces concrete from the cementitious material. S430 can be performed after S300 (e.g., after the activated mixture has the desired properties). S430 can occur in batches or continuously. S430 can be performed using concrete mixers, concrete plants, drum mixers, industrial mixers, by hand, and/or using any other mixing mechanism.

In certain embodiments, S430 comprises adding a predetermined amount of water to the cementitious material, mixing the water and cementitious material to form a slurry (e.g., with target uniformity, target viscosity, thickness, etc.). For example, the composition of water in the mixture can be about 30%, 40%, 50%, 60%, 70% by weight of the cementitious material.

S430 can optionally include mixing in additives such as plasticizers, accelerators, retarders, aggregates, sand, gravel, crushed stones, clay, and/or any other additives.

During and/or after S430, the concrete can be shaped, poured, molded, and/or otherwise be processed.

The concrete is preferably cured for a curing time (e.g., 1 day, 3 days, 7 days, 8 days, 10 days, 15 days, 28 days, 30 days, 60 days, 90 days, etc.) after which the concrete is preferably set.

In certain preferred embodiments, after setting, the cementitious material as described above meets or exceeds the mechanical properties of other hydraulic cements (e.g., Portland cement, alite, belite, tricalcium aluminate, brownmillerite, etc.). In further embodiments, after 7 days for setting (e.g., drying after being mixed with water), the cementitious material has a compressive strength exceeding about 3 MPa (e.g., about 5 MPa, 7 MPa, 8 MPa, 10 MPa, 12 MPa, 15 MPa, 20 MPa, 25 MPa, 28 MPa, 30 MPa, 40 MPa, etc.). In yet further embodiments, after 28 days for setting, the cementitious material has a compressive strength exceeding about 5 MPa (e.g., about 7 MPa, 9 MPa, 10 MPa, 12 MPa, 15 MPa, 20 MPa, 25 MPa, 28 MPa, 30 MPa, 35 MPa, 40 MPa, 44 MPa, 50 MPa, 52 MPa, 58 MPa, 61 MPa, 65 MPa, 70 MPa, values or ranges therebetween, etc.). In still further embodiments, after 90 days for setting, the cementitious material has a compressive strength exceeding about 7.5 MPa (e.g., about 10 MPa, 12 MPa, 15 MPa, 20 MPa, 25 MPa, 28 MPa, 30 MPa, 33 MPa, 35 MPa, 36 MPa, 40 MPa, 44 MPa, 50 MPa, 52 MPa, 58 MPa, 61 MPa, 65 MPa, 70 MPa, 77 MPa, 82 MPa, 85 MPa, 90 MPa, 93 MPa, 96 MPa, 98 MPa, 100 MPa, 110 MPa, values or ranges therebetween, etc.). However, the cementitious material can achieve other suitable compressive strength.

In certain embodiments, the cementitious material achieves comparable or superior chemical stability of cement, freeze-thaw behavior, and/or other suitable properties as compared to Portland cement (or other hydraulic cement). In further embodiments, cement formed using a cementitious material as described above has superior stability to sulphate (e.g., sulfuric acid). One hypothesis as to the source of this improved chemical resistance is because of a reduced aluminum content in the cementitious material (as compared to Portland cement); however, other aspects of the cementitious material can additionally or alternatively contribute to or result in the improved chemical stability.

Testing the calcium-silica mix S440 functions to assess the quality and/or properties of the cementitious material. S440 can involve particle size testing (e.g., via sieving, optical imaging, microscopy, dynamic light scattering, x-ray diffraction, electron imaging, electron diffraction, vibrational spectroscopy, etc.), chemical composition analysis (e.g., X-ray diffraction, thermogravimetric analysis, Raman spectroscopy, acid tests, etc.), crystallographic analyses (e.g., x-ray diffraction, vibrational spectroscopy, FTIR, Raman, nuclear magnetic resonance spectroscopy, electron diffraction, etc.), concrete setting time and/or hardness testing (e.g., using a sclerometer at predetermined intervals during or after S430). S440 can additionally or alternatively include testing silicon oxide and/or calcium species (e.g., calcium oxide, limestone, calcined limestone, etc.).

### 5. Cementitious Material

As shown in FIG. 1, a cementitious material can include particles made from (e.g., consisting of, composed of, consisting essentially of, composed essentially of, including predominantly, with a majority composition of, including, comprising, etc.) substoichiometric calcium content relative to silicon content.

The cementitious material preferably includes a calcium silicate. The calcium silicate is preferably substoichiometric in calcium relative to silicon. The stoichiometric ratio of calcium to silicon is preferably between about 0.1 and about 0.8. When the stoichiometric ratio of calcium is less than 0.1, the resulting cementitious material can have a lower (e.g., less than a target value, insufficient, less than desirable, etc.) compressive strength. Relatedly, higher stoichiometric ratios can result in a high carbon intensity (e.g., CO₂ emissions greater than about 1 kg CO₂ emitted/kg of cementitious material produced).

The calcium silicate is preferably amorphous or nanocrystalline (e.g., has crystal grains with a characteristic size less than about 100 nm). For example, the calcium silicate can have a grain size between about 0.01 nm and about 100 nm (e.g., about 0.01 nm, 0.1 nm, 1 nm, 10 nm, 20 nm, 30 nm, 40 nm, 50 nm, 60 nm, 70 nm, 80 nm, 90 nm, 100 nm, and/or any value or range therebetween). However, the calcium silicate can have any suitable crystallinity and/or crystal grain size. In some embodiments, the crystallinity (or lack thereof) is measured using x-ray diffraction (e.g., based on a linewidth, peak position, etc. in x-ray diffraction scans), x-ray photoelectron spectroscopy, nuclear magnetic resonance spectroscopy, electron diffraction, scanning transmission electron micrographs (STEM), vibrational spectroscopy (e.g., resonant vibration transition frequencies, vibrational transition linewidths, etc. such as Raman, Fourier transform infrared spectroscopy, etc.), and/or other suitable techniques.

The calcium silicate is preferably particulate. In certain embodiments, the calcium silicate is pelletized, powdered, granular, fibrous, agglomerated, or in a bulk solid form. In some embodiments in which the calcium silicate is particulate, a characteristic size (e.g., D50 size, diameter, hydrodynamic radius, Stokes radius, width, length, depth, etc.) of the particles is between about 100 nm and 100 μm (e.g., about 200 nm, 500 nm, 1 μm, 2 μm, 5 μm, 10 μm, 20 μm, 50 μm, values or ranges therebetween, etc.). When particles are less than about 100 nm, forming a slurry of particles (e.g., to form cement) may be difficult (e.g., the viscosity, flow, etc. properties of the slurry can be inadequate for formation of cement, a curing time can be too long, etc.). Similarly, cements formed from cementitious material the includes calcium silicate with characteristic particle size greater than 100 μm may have inadequate properties (e.g., low compressive strength) from issues with curing, slurry stability, and/or other problems. The characteristic size can be measured using vibrational spectroscopy, x-ray diffraction, direct imaging (e.g., electron beam imaging, neutron imaging, etc.), dynamic light scattering, and/or using other suitable techniques.

In certain embodiments, the calcium silicate particles exhibit a high specific surface area. In some embodiments, the specific surface area of the calcium silicate particles can be between about 5 m²/g and about 200 m²/g (e.g., about 5 m²/g, 10 m²/g, 20 m²/g, 30 m²/g, 40 m²/g, 50 m²/g, 75 m²/g, 100 m²/g, 125 m²/g, 150 m²/g, 175 m²/g, 200 m²/g, and/or any value or range therebetween). In further embodiments, the specific surface area is between about 200 m²/g and about 10,000 m²/kg (e.g., about 500 m²/kg, 1,000 m²/kg, 2,000 m²/kg, 4,000 m²/kg, 5,000 m²/kg, 7,500 m²/kg, 10,000 m²/kg, and/or any value or range therebetween). In yet further embodiments, the specific surface area exceeds about 10,000 m²/kg. The specific surface area can be measured using Brunauer-Emmett-Teller (BET) nitrogen adsorption, krypton adsorption, water vapor adsorption, or other suitable gas adsorption techniques. A high specific surface area can enhance hydration kinetics, increase chemical reactivity, promote formation of binding phases during curing, and/or enable hydraulic activity even at reduced calcium-to-silicon ratios.

In embodiments where the cementitious material is formed from calcium oxide and silicon oxide precursors, the relative amounts of calcium oxide and silicon oxide are selected to yield a desired calcium-to-silicon ratio in the resulting calcium silicate. In certain embodiments, the ratio of calcium oxide to silicon oxide is defined on a molar basis, a mass basis, a weight percent basis, a volume basis, and/or a stoichiometric basis. In further embodiments, the calcium oxide and silicon oxide are combined in relative molar amounts selected to yield a calcium-to-silicon atomic ratio between about 0.1 and about 0.8 (e.g., about 0.1, 0.15, 0.2, 0.25, 0.3, 0.35, 0.4, 0.45, 0.5, 0.6, 0.7, 0.8, and/or any value or range therebetween). In yet further embodiments, the calcium oxide is between about 5 wt % and about 60 wt % of the combined calcium oxide and silicon oxide (e.g., about 5 wt %, 10 wt %, 15 wt %, 20 wt %, 25 wt %, 30 wt %, 35 wt %, 40 wt %, 45 wt %, 50 wt %, 55 wt %, 60 wt %, and/or any value or range therebetween), where the remainder is silicon oxide and/or additives. In still further embodiments, the calcium oxide and silicon oxide are combined in non-stoichiometric proportions relative to crystalline calcium silicate phases, such that the resulting calcium silicate is amorphous or nanocrystalline. Selecting the relative amounts of calcium oxide and silicon oxide can control the phase composition, degree of polymerization of silicate units, defect density, surface chemistry, hydraulic reactivity, and/or carbon intensity of the resulting cementitious material.

The additives are preferably at most about 10 wt % of the cementitious material. The 10 wt % can refer to a total wt % of additives and/or a wt % of a specific additive (where each additive can contribute up to about 10 wt % each).

However, in some embodiments (particularly but not exclusively when the additives include silica or other silicon oxide species such as quartz), the additives are up to about 60 wt % of the cementitious material. In certain embodiments, a cementitious material comprises about 10 wt % aluminum oxide (or related aluminum minerals such as aluminosilicates, calcium aluminates, calcium aluminosilicates, etc.), about 50 wt % silica, and about 40 wt % calcium silicate (e.g., as described above). However, other compositions can be used (up to and including about 100 wt % calcium silicate).

The additives composition can be determined using x-ray fluorescence, particle-induced X-ray emission, X-ray photoelectron spectroscopy, Auger electron spectroscopy, mass spectrometry, energy-dispersive X-ray spectroscopy, cathodoluminescence, nuclear magnetic resonance spectroscopy, and/or using other suitable technique(s).

### 6. Specific Examples

Specific Example 1. A method of forming a cementitious material, comprising: comminuting a silicon oxide material to form silicon oxide particles having a characteristic particle size between 0.01 μm and 1 μm and an amorphous or nanocrystalline structure; combining the silicon oxide particles with a calcium-containing material in relative amounts selected to yield a sub-stoichiometric calcium content relative to silicon to form a calcium-silicon mixture, wherein the calcium-containing material is selected from the group consisting of calcium oxide, calcium hydroxide, calcium carbonate, and combinations thereof; and mechanically activating the calcium-silicon mixture until calcium silicate particles are formed.

Specific Example 2. The method of Specific Example 1, wherein mechanically activating the calcium-silicon mixtures comprises milling the calcium-silicon mixture in a ball mill or stirred media mill.

Specific Example 3. The method of Specific Example 2, wherein co-milling the calcium-silicon mixture comprises milling the calcium-silicon mixture with milling media at a milling medium-to-calcium-silicon mixture mass ratio between 15:1 and 25:1.

Specific Example 4. The method of Specific Example 2, wherein co-milling the calcium-silicon mixture comprises milling the calcium-silicon mixture at a rate between 50 and 400 RPM.

Specific Example 5. The method of Specific Example 1, wherein mechanically activating the calcium-silicon mixture comprises maintaining the calcium-silicon mixture at a temperature below 800° C.

Specific Example 6. The method of Specific Example 1, wherein the calcium-containing material comprises a powder morphology with a particle size between 10 μm and 100 μm.

Specific Example 7. The method of Specific Example 1, wherein a calcium-to-silicon atomic ratio of the calcium silicate particles is between about 0.1 and about 0.8.

Specific Example 8. The method of Specific Example 1, further comprising drying the milled calcium silicate particles to a residual moisture content of less than 5% by weight.

Specific Example 9. The method of Specific Example 1, further comprising decomposing the calcium-containing material in a furnace prior to combining the silicon oxide particles with the calcium-containing material.

Specific Example 10. A method of forming concrete, comprising: mixing a cementitious material with water to form a cement slurry, wherein the cementitious material comprises mechanically activated calcium silicate particles formed by co-milling silicon oxide with a calcium-containing material, wherein a calcium-to-silicon atomic ratio of the cementitious material is less than 0.75; and curing the cement slurry to form the concrete.

Specific Example 11. The method of Specific Example 10, wherein the silicon oxide comprises a characteristic particle size between 10 nm and 100 nm and the calcium-containing material comprise a characteristic particle size between 10 μm and 100 μm.

Specific Example 12. The method of Specific Example 10, wherein a water-to-cementitious-material ratio is between about 0.1 and 1.0 by mass.

Specific Example 13. The method of Specific Example 10, wherein curing occurs at ambient humidity and ambient pressure.

Specific Example 14. The method of Specific Example 10, further comprising mixing the cement slurry with an additive, wherein the additive comprises an aggregate, wherein the aggregate comprises at least one of sand or gravel.

Specific Example 15. The method of Specific Example 10, further comprising mixing the cement slurry with an additive, wherein the additives are selected from gypsum, pozzolanic materials, aluminosilicates, fibers, plasticizers, or alkaline substances.

Specific Example 16. A cementitious material, comprising a calcium silicate powder formed by milling silicon oxide with calcium oxide in relative molar amounts selected to yield a calcium-to-silicon atomic ratio between about 0.1 and about 0.75.

Specific Example 17. The cementitious material of Specific Example 16, wherein forming the calcium silicate powder further comprises milling the silicon oxide to a particle size between 10 nm and 100 nm and a nanocrystalline structure prior to milling the silicon oxide with the calcium oxide.

Specific Example 18. The cementitious material of Specific Example 16, wherein the calcium silicate powder has a specific surface area between about 1000 m²/kg and about 10000 m²/kg.

Specific Example 19. The cementitious material of Specific Example 16, wherein forming the calcium silicate powder further comprises washing the calcium silicate powder with a solvent to remove impurities soluble in the solvent.

Specific Example 20. The cementitious material of Specific Example 16, wherein the calcium silicate powder is amorphous or nanocrystalline.

Embodiments of the system can include every combination and permutation of the various system components. Components of the preceding system can be used with, in addition to, in lieu of, or otherwise integrated with all or a portion of the systems and/or methods disclosed in the applications mentioned above, each of which are incorporated in their entirety by this reference.

As used herein, “substantially” or other words of approximation (e.g., “about,” “approximately,” etc.) can be within a predetermined error threshold or tolerance of a metric, component, or other reference (e.g., within 0.001%, 0.01%, 0.1%, 1%, 5%, 10%, 20%, 30% of a reference), or be otherwise interpreted.

As a person skilled in the art will recognize from the previous detailed description and from the figures and claims, modifications and changes can be made to the preferred embodiments of the invention without departing from the scope of this invention defined in the following claims.

### EXAMPLES

The invention now being generally described, it will be more readily understood by reference to the following examples which are included merely for purposes of illustration of certain aspects and embodiments of the present invention and are not intended to limit the invention.

### Example 1: Exemplary Preparation of a CaO:SiO2 Compositions

An exemplary CaO:SiO₂ was prepared according to the following procedure.

First, approximately 500 grams of SiO₂ particles (typically quartz) having an initial median particle size of approximately ~100 mm were charged into a planetary ball mill equipped with steel milling media. The SiO₂ particles were milled at a rotational speed of 400 rpm, with an approximate ball to powder ratio of 50, for an approximate period of 300 minutes resulting in SiO₂ particles having a reduced median particle size of approximately 1 μm.

Following the first milling step, approximately 140 grams of CaO particles having an initial median particle size of approximately 100 μm were added to the mill containing the milled SiO₂ particles. The mixture of particles was then milled for approximately 15 minutes to yield an exemplary composition.

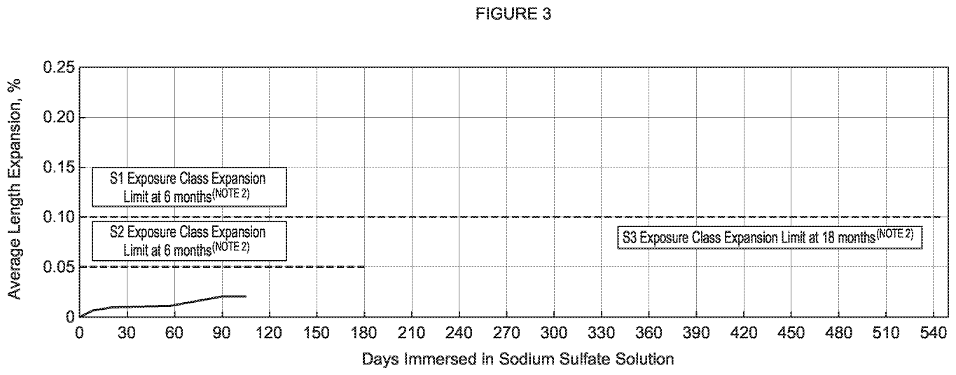

TABLE 1
Average Expansion % of the cementitious materials described herein when exposed to a
sulfate solution for 105 days (FIG. 3)

| | | | | | | | | | Coefficient | Average |
|---|---|---|---|---|---|---|---|---|---|---|
| | Days in | Specimen Expansion, % | | | | | | Standard | of | Expansion |
| Date | Solution | A | B | C | D | E | F | Deviation % | Variation | % |
| Jun. 11, 2025 | 0 | 0.000 | 0.000 | 0.000 | 0.000 | 0.000 | 0.000 | 0.000 | | 0.00 |
| Jun. 18, 2025 | 7 | 0.005 | 0.006 | 0.007 | 0.005 | 0.007 | 0.006 | 0.001 | 0.149 | 0.01 |
| Jun. 25, 2025 | 14 | 0.008 | 0.009 | 0.008 | 0.007 | 0.009 | 0.008 | 0.001 | 0.092 | 0.01 |
| Jul. 2, 2025 | 21 | 0.009 | 0.011 | 0.010 | 0.009 | 0.010 | 0.010 | 0.001 | 0.077 | 0.01 |
| Jul. 9, 2025 | 28 | 0.009 | 0.011 | 0.010 | 0.009 | 0.010 | 0.010 | 0.001 | 0.077 | 0.01 |
| Aug. 6, 2025 | 56 | 0.011 | 0.013 | 0.012 | 0.010 | 0.011 | 0.011 | 0.001 | 0.091 | 0.01 |
| Sep. 10, 2025 | 91 | 0.020 | 0.023 | 0.022 | 0.019 | 0.020 | 0.020 | 0.002 | 0.073 | 0.02 |
| Sep. 24, 2025 | 105 | 0.020 | 0.023 | 0.022 | 0.019 | 0.020 | 0.020 | 0.002 | 0.073 | 0.02 |
| Oct. 9, 2025 | 120 | | | | | | | | | |
| Dec. 8, 2025 | 180 | | | | | | | | | |
| Mar. 8, 2026 | 270 | | | | | | | | | |
| Jun. 11, 2026 | 365 | | | | | | | | | |

TABLE 2
ASTM C1157 Standard Physical Requirements

| | GU | HE | MS |
|---|---|---|---|
| Fineness, specific surface: | | | |
| No. 325 sieve, % retained | — | — | — |
| Air permeability test, min. m²/kg: | — | — | — |
| Density, g/cm³: | | | |
| Time of Setting, Vicat test | | | |
| Initial, not less than, min. | 45 | 45 | 45 |
| Initial, not more than, min. | 420 | 420 | 420 |
| Final, min | — | — | — |
| Normal Consistency (wt %) | — | — | — |
| Air content of mortar, volume % | 12 | 12 | 12 |
| Strength, compression, min., MPa (psi) | | | |
| Mortar flow (%) | 110 ± 5 | 110 ± 5 | 110 ± 5 |
| 1 day | — | 12.0 | — |
| | | (1740) | |
| 3 days | 13.0 | 24.0 | 11.0 |
| | (1890) | (3480) | (1600) |
| 7 days | 20.0 | — | 18.0 |
| | (2900) | | (2610) |
| 28 days | 28.0 | — | — |
| | (4060) | | |
| Water Requirement, max wt % cement: | — | — | — |
| Heat of Hydration (ASTM | | | |
| C1702), max kj/kg (cal/g) | | | |
| 3 days | — | — | — |
| 7 days | — | — | — |
| Mortar bar expansion (ASTM C1038) | | | |
| 14 days, % max | 0.020 | 0.020 | 0.020 |
| Sulfate Resistance (ASTM C1012) | | | |
| 6 months, max % | | | 0.10 |
| 1 year, max % | — | — | — |
| Option A - Air Entraining Air | | | |
| Content of mortar, vol % | | | |
| max | 22 | 22 | 22 |
| min | 16 | 16 | 16 |
| Option R - Low reactivity | | | |
| with alkali-silica-reactive | | | |
| aggregates^{G}, Expansion at | | | |
| 14 days, max % | 0.020 | 0.020 | 0.020 |
| 56 days, max % | 0.060 | 0.060 | 0.060 |
| Early Stiffening - Final Penetration, min % | 50 | 50 | 50 |
| Compressive Strength 28 day, min MPa (psi) | — | — | 28.0 |
| | | | (4060) |

TABLE 3
ASTM C1157 Standard Physical Requirements

| | | | Client ID: | GU C1157 |
|---|---|---|---|---|
| HS | MH | LH | CTL ID: | 5906801 |
| — | — | — | | 24.4 |
| — | — | — | | 897 |
| — | — | — | | 2.57 |
| 45 | 45 | 45 | | |
| 420 | 420 | 420 | | |
| — | — | — | | |
| — | — | — | | |
| 12 | 12 | 12 | | 16 |
| 110 ± 5 | 110 ± 5 | 110 ± 5 | | 114 |
| — | — | — | | 6.0 |
| | | | | (870) |
| 11.0 | 5.0 | — | | 21.2 |
| (1600) | (725) | | | (3080) |
| 18.0 | 11.0 | 11.0 | | 37.9 |
| (2610) | (1600) | (1600) | | (5500) |
| 25.0 | — | 21.0 | | 48.7 |
| (3620) | | (3050) | | (7060) |
| — | — | — | | 36.0 |
| — | 335 | 200 | | 208 |
| | (80) | (50) | | (49.6) |
| — | — | 225 | | 269 |
| | | (55) | | (64.2) |
| 0.020 | 0.020 | 0.020 | | 0.021 |
| 0.05^{E} | — | — | | 0.02 |
| 0.10^{E} | — | — | | Pending |
| 22 | 22 | 22 | | 16 |
| 16 | 16 | 16 | | |
| 0.020 | 0.020 | 0.020 | | |
| 0.060 | 0.060 | 0.060 | | |
| 50 | 50 | 50 | | |
| — | 22.0 | — | | 48.7 |
| | (3190) | | | (7060) |

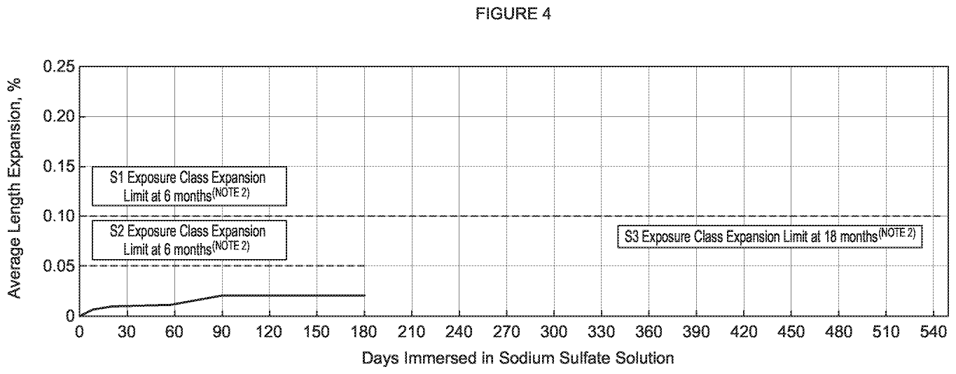

TABLE 4
Average Expansion % of the cementitious materials described herein when exposed to a
sulfate solution for 180 days (FIG. 4)

| | | | | | | | | | Coefficient | Average |
|---|---|---|---|---|---|---|---|---|---|---|
| | Days in | Specimen Expansion, % | | | | | | Standard | of | Expansion |
| Date | Solution | A | B | C | D | E | F | Deviation % | Variation | % |
| Jun. 11, 2025 | 0 | 0.000 | 0.000 | 0.000 | 0.000 | 0.000 | 0.000 | 0.000 | | 0.00 |
| Jun. 18, 2025 | 7 | 0.005 | 0.006 | 0.007 | 0.005 | 0.007 | 0.006 | 0.001 | 0.149 | 0.01 |
| Jun. 25, 2025 | 14 | 0.008 | 0.009 | 0.008 | 0.007 | 0.009 | 0.008 | 0.001 | 0.092 | 0.01 |
| Jul. 2, 2025 | 21 | 0.009 | 0.011 | 0.010 | 0.009 | 0.010 | 0.010 | 0.001 | 0.077 | 0.01 |
| Jul. 9, 2025 | 28 | 0.009 | 0.011 | 0.010 | 0.009 | 0.010 | 0.010 | 0.001 | 0.077 | 0.01 |
| Aug. 6, 2025 | 56 | 0.011 | 0.013 | 0.012 | 0.010 | 0.011 | 0.011 | 0.001 | 0.091 | 0.01 |
| Sep. 10, 2025 | 91 | 0.020 | 0.023 | 0.022 | 0.019 | 0.020 | 0.020 | 0.002 | 0.073 | 0.02 |
| Sep. 24, 2025 | 105 | 0.020 | 0.023 | 0.022 | 0.019 | 0.020 | 0.020 | 0.002 | 0.073 | 0.02 |
| Oct. 9, 2025 | 120 | 0.020 | 0.023 | 0.022 | 0.019 | 0.020 | 0.020 | 0.002 | 0.073 | 0.02 |
| Dec. 8, 2025 | 180 | 0.020 | 0.023 | 0.022 | 0.019 | 0.020 | 0.020 | 0.002 | 0.073 | 0.02 |
| Mar. 8, 2026 | 270 | | | | | | | | | |
| Jun. 11, 2026 | 365 | | | | | | | | | |

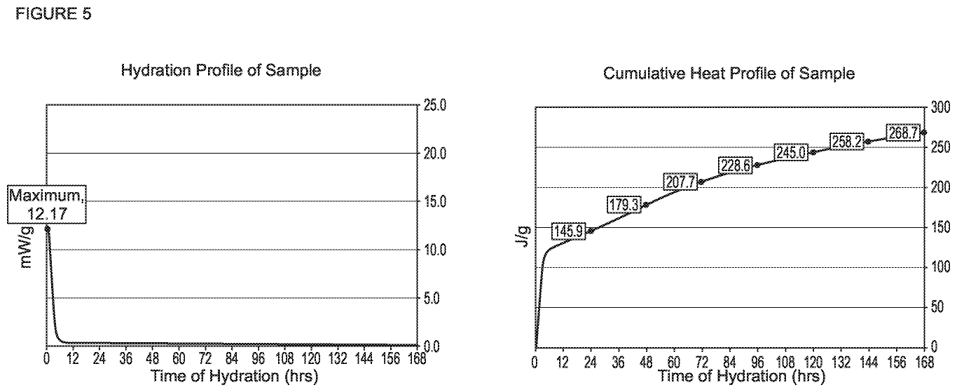

TABLE 5
Parameters for isothermal conduction calorimetry analysis
of the cementitious materials described herein (FIG. 5).

| | |
|---|---|
| Maximum Rate, mW/g | 12.1700 |
| Time Maximum Rate | 0:52 |
| Recorded, HH:mm | |
| Water-cement ratio | 0.500 |
| Mass cement tested, grams | 3.333 |
| Mass of paste tested, grams | 5.000 |

TABLE 6
Total heat from an isothermal conduction calorimetry
analysis of the cementitious materials described herein.
Testing was conducted at 23° C. (FIG. 5).
Total Heat

| Time (HH.mm) | (J/g) | (Cal/g) | Time (DD-hh) |
|---|---|---|---|
| 24 | 145.9 | 34.9 | 1 D - 24 Hr |
| 48 | 179.3 | 42.8 | 2 D - 24 Hr |
| 72 | 207.7 | 49.6 | 3 D - 24 Hr |
| 96 | 228.6 | 54.6 | 4 D - 24 Hr |
| 120 | 245.0 | 58.5 | 5 D - 24 Hr |
| 144 | 258.2 | 61.7 | 6 D - 24 Hr |
| 168 | 268.7 | 64.2 | 7 D - 24 Hr |

### INCORPORATION BY REFERENCE

All publications and patents mentioned herein are hereby incorporated by reference in their entirety as if each individual publication or patent was specifically and individually indicated to be incorporated by reference. In case of conflict, the present application, including any definitions herein, will control.

### EQUIVALENTS

While specific embodiments of the subject invention have been discussed, the above specification is illustrative and not restrictive. Many variations of the invention will become apparent to those skilled in the art upon review of this specification and the claims below. The full scope of the invention should be determined by reference to the claims, along with their full scope of equivalents, and the specification, along with such variations.

1. A composition comprising a plurality of X(CaO) particles and a plurality of Y(SiO₂) particles, wherein X:Y is from about 0.05 to about 0.095 or about 1.05 to about 5.00.

2-105. (canceled)

106. The composition of claim 1, wherein the composition is cementitious.

107. The composition of claim 1, wherein the SiO₂ particles have an average particle size from about 10 nm to about 15 microns.

108-116. (canceled)

117. The composition of claim 1, wherein the CaO particles have an average particle size from about 10 nm to about 15 microns.

118-126. (canceled)

127. The composition of claim 1, wherein the SiO₂ particles have a diameter 50 (D50) of from about 0.5 microns to about 50 microns.

128-141. (canceled)

142. The composition of claim 1, wherein the CaO particles have a diameter 50 (D50) of from about 0.5 microns to about 50 microns.

143-156. (canceled)

157. The composition of claim 1, wherein the plurality of X(CaO) particles and the plurality of Y(SiO₂) particles are arranged in a disordered structure.

158. The composition of claim 1, wherein the plurality of X(CaO) particles and the plurality of Y(SiO₂) particles are arranged in an ordered structure.

159. The composition of claim 1, wherein the composition is amorphous.

160. The composition of claim 1, wherein the composition is crystalline.

161. The composition of claim 1, wherein the SiO₂ is from a natural source.

162. The composition of claim 1, wherein the SiO₂ is from a synthetic source.

163. The composition of claim 1, wherein the SiO₂ is from rocks or fly ash.

164. (canceled)

165. The composition of claim 1, wherein the density of the composition is from about 1.2 g/cm³ to about 5 g/cm³.

166-184. (canceled)

185. The composition of claim 1, wherein the composition can form a hydrate.

186. (canceled)

187. The composition of claim 1, wherein the composition has a ratio of Ca:Si from about 0.05:1 to about 0.095:1 or about 1.05:1 to about 5:1 by wt %.

188-232. (canceled)

233. A method of preparing a composition comprising a plurality of first CaO particles and a plurality of first SiO₂ particles, wherein the method comprises:
in a first milling step, milling a plurality of first SiO₂ particles in a mill, thereby forming a plurality of first milled SiO₂ particles;
contacting the plurality of first milled SiO₂ particles with a plurality of first CaO particles in the mill, thereby forming a mixture of a plurality of remilled SiO₂ particles and a plurality of first milled CaO particles; and
in a second milling step, milling the mixture of the plurality of remilled SiO₂ particles and the plurality of first milled CaO particles, thereby forming the composition comprising the plurality of first CaO particles and the plurality of first SiO₂ particles.

234-368. (canceled)

369. A construction material comprising the composition of claim 1.

370-391. (canceled)

392. The composition of claim 161, wherein the natural source is selected from sand, such as quartz sand, quartzite, quartz, opal, agate, or granite.

393. The composition of claim 162, wherein the synthetic source is selected from pyrogenic silica, precipitated silica, silica gel, colloidal silica, or silica glass.
